(19) United States
(12) Patent Application Publication
(10) Pub. No.: US 2010/0217714 A1
(43) Pub. Date: Aug. 26, 2010

(54) Telenostics certify

(75) Inventors: Ronald E. Wagner, Fleming Island, FL (US); Robert Ufford, Roswell, GA (US)

Correspondence Address: ROBERT K. TENDLER, 65 ATLANTIC AVENUE, BOSTON, MA, 02110, US

(73) Assignee: BAE Systems Information and Electronic Systems Integration, Inc.

(21) Appl. No.: 12/660,248

(22) Filed: Feb. 23, 2010

Related U.S. Application Data
(60) Provisional application No. 61/154,638, filed on Feb. 23, 2009.

(51) Int. Cl. G06Q 10/00; G06Q 50/00

(52) U.S. Cl. 705/301; 705/348; 705/305

(57) ABSTRACT

A method for managing a commercial process comprising the steps of capturing and understanding current as-is processes; comparing before and after performance; developing a transition strategy; evaluating performance using flow charts; redesigning using creative thinking; obtaining real-time data about the process; performing predictive performance actions based on remaining useful life; and performing aggregation, analysis and information fusion to enable process and users to optimize the commercial process.

### RELATED APPLICATIONS

This Application claims rights under 35 USC §119(e) from U.S. application Ser. No. 61/154,638 filed Feb. 23, 2009, the contents of which are incorporated herein by reference.

### FIELD OF THE INVENTION

The present invention relates to a computerized evaluation system for program or system performance and more particularly to methods for integrating various capabilities in a web-based performance management and optimization suite.

### BACKGROUND OF THE INVENTION

Many companies are involved in processes which are in need of evaluation and redesign in order to effectuate better performance and savings. While in the past methodologies have existed for providing robust business cases and business plans, when a manager is faced with an underperforming process or system, the prior approach to obtaining better yields or acceptability has been to assess mission performance but usually in a haphazard and disconnected manner. The result is that improvements in various sub-processes do not necessarily result in overall better performance or savings due to unintended consequences and information that while available, has not been brought to the fore in making management decisions.

Thus, mission performance is to be improved that results in a lower total ownership cost and a methodology is clearly required to take into account all of the factors in a complete process in order to develop a systematic approach in order to assure complete flow of information and to be able to design a solution that guarantees that system needs are met. What is in short required is a total data capture and a complete cause and effect analysis so that one can take existing infrastructure and processes and implement changes to the infrastructure or processes to assure a beneficial result that can increase performance and reduce overall operating costs.

One of the processes for which improvement is desired is a fleet management process which is addressed in one application by U.S. patent application Ser. No. ______ (docket number BAEP-1159), entitled Telenostics, filed on even date, assigned to the assignee hereof and incorporated herein by reference. Here a method known as Telenostics develops realtime data regarding remote and mobile assets, and formulates maintenance plans and procedures used to improve fleet operations. The Telenostics operation while providing fleet managers with realtime data and information permits the fleet mangers to provide additional or refined maintenance tasks. However the Telenostics system with its diagnostic and prognostic algorithms is nonetheless in need of a methodology that assures taking into account all of the information available and providing specific suggestions for improvement of the process based on a rigorous and complete analysis of the process itself.

By way of further background, the telenostics method addresses remote and mobile assets as well as fleet operations. This method enhances mission performance at a lower total ownership cost. The operational principles guide movement to the point of performance those actions that achieve mission performance with a minimum of infrastructure. It is not just about getting a current snapshot of operations.

Note, Telenostic systems are described in the following U.S. patent applications, filed on even date herewith, assigned to the assignee hereof and incorporated herein by reference: Ser. No. ______ (docket number BAEP 1140) Diagnostic Connector Assembly (DCA) Interface Unit (DIU), Ser. No. ______ (docket number BAEP 1141) In Service Support Center and Method of Operation, Ser. No. ______ (docket number BAEP 1159) Telenostics, Ser. No. ______ (docket number BAEP 1160) Portable Performance Support Device and Method for Use, and Ser. No. ______ (docket number BAEP 1161) Telenostics Performance Logic.

A need, however, still exists to improve the telenostics method.

### SUMMARY OF INVENTION

What is provided by the subject system is a computer-assisted evaluation and recommendation system based on templates that are used to prompt individuals to answer questions that assure completeness of the evaluation as well as completeness of the suggested response and the assurance of follow-ups. The methodology involves templates which by prompting force capture of information, the evaluation of this information, compilation of a redesign tasks, generation of targeting task, task implementation and a follow-up proceeding which is turn followed by justifications for the proposed changes to a process.

By applying the computerized methodology and templates, one arrives at performance-based solutions for optimizing performance in which business intelligence can be improved by providing timely information, adapted to provide only the relevant knowledge that most affects performance outcomes and then takes advantage of multitudes of databases and information to assure completeness and effectiveness of the evaluation and recommendation process.

The subject system takes a business model for an industry and takes advantage of the factors, metrics and knowledge which most influences the desirable performance of the system to be evaluated. The result is a targeted solution tailored towards newer modified performance needs.

In one embodiment, subject methodology involves a capture phase intended to document the concurrent or as-is processes involved because it is important to understand the starting condition in order to assess the potential benefits of a redesign effort and compare “before and after” performance. Being able to document the as-is condition also results in the development of a transition strategy and ability to assess the resources associated with the transition activity required in a redesign. Thus, the capture phase establishes the foundation for an evaluation phase to identify targets of opportunity that warrant special attention in a redesign effort.

In the evaluation stage the objective of the evaluation activity is to reach a common understanding of the problems involved and the process to be evaluated. The evaluation results in identifying key performance drivers that must be addressed in any redesign effort.

It is noted that redesign involves sewing the seeds of imagination, meaning a creative approach to establishing a new process.

There are many appropriate principals to guide the redesign effort and in particular, in one embodiment the subject approach to redesign is a two-step approach.

The first step is to prompt creative re-think process steps to eliminate and reduce identified issues.

The second step is to apply realtime methodologies to achieve the desired end results.

In summary, what is provided is a computer-aided prompting system involving the use of templates for forcing the evaluation into a c-capture, e-evaluation, r-redesign, t-target, i-implementation and an f-follow up process, so that upon using the templates, complete analysis of an entire process is assured. Targeted redesign implementation which is the result of the evaluation thus entails in-depth and complete solutions to identified system problems.

According to one embodiment of the present invention, users are provided with performance based solutions for optimizing the performance metrics that are most important to their industry desires. Business intelligence can be improved by accessing information that is timely, adapted to provide only the relevant knowledge that most affects performance outcomes, and can take advantage of multitudes of databases and information that can be brought to bear without the internal investment requiring IT or development personnel. As the business model changes, and the factors/metrics/knowledge which most influence desirable performance objectives change, the result is that the performance logic model can change as well as the required level of information needs. This reduces or increases subscription costs, but ultimately increases revenue by the operating/total life cycle savings, with the ability to target a solution tailored toward new or modified performance needs.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of the subject prompting system in which prompts relating to capture, evaluation, redesign, target, implementation, follow-up and yield are generated by a processor driving a display or printer in which templates are utilized to prompt an individual to enter data which assist in the evaluation of a particular system and result in a suggested course of action;

FIG. 2 is a chart illustrating the types of templates utilized in the capture, evaluation, redesign, targeting, implementation and follow-up portions of the subject CERTIFY system;

FIG. 3 is a capture worksheet checklist template for use in the subject prompting system;

FIG. 4 is a an evaluation worksheet checklist template for use in the subject system;

FIG. 5 is a redesign worksheet checklist template for use in the subject system;

FIG. 6 is a target worksheet checklist template for use in the subject system;

FIG. 7 is a diagrammatic illustration of an implementation checklist template for use in the subject system;

FIG. 8 is a diagrammatic illustration of a follow-up worksheet checklist template for use in the subject system; and,

FIG. 9-56 are templates presented by the subject system which may be provided in the form of dialog boxes for the entry of information by a user in order to satisfy the requirements of the subject CERTIFY system.

### DETAILED DESCRIPTION

The subject CERTIFY system is a computer-assisted system to be able to prompt individuals to take into account all of the processes of a particular system to evaluate the processes, to redesign the processes, to provide targeted assessment of the results of the capture, evaluate and redesign stages, to prompt the steps for the implementation of the targeted redesign and to prompt follow-up processes, whereby the CERTIFY system assures completeness and provides a targeted redesign for any system under analysis.

By way of example only, a telenostics system is discussed in terms of the specific prompting templates; it being understood that other systems other than a telenostics system primarily used for fleet management may take advantage of the CERTIFY system, thus to be able to provide better system performance, whatever the system is, and to provide concomitant cost savings.

The letters of the CERTIFY system correspond to prompts in particular areas which when a template is then filled out, the result is an exceedingly complete approach to solving problems in existing systems.

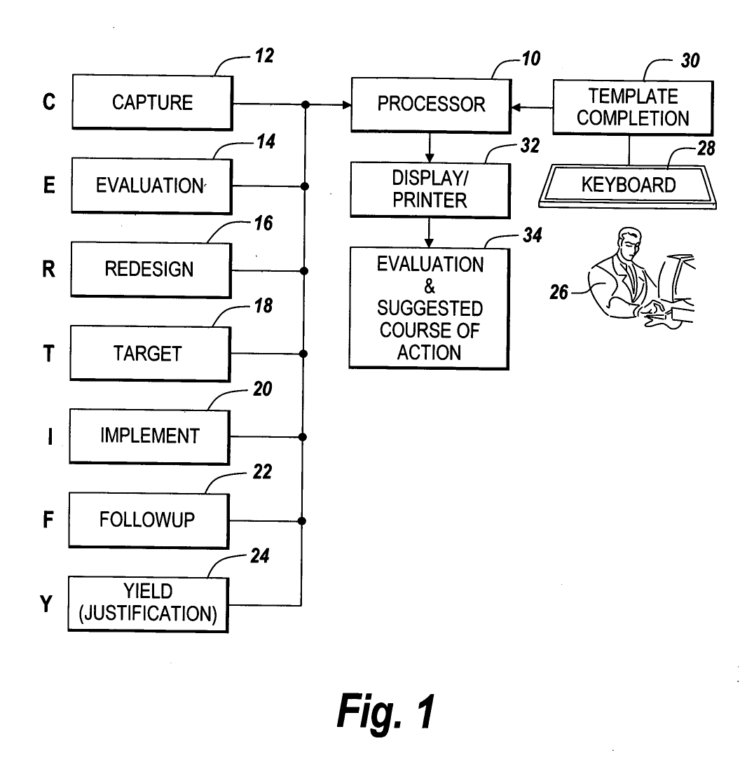

Referring now to FIG. 1, the CERTIFY system uploads templates to a processor 10, in which the templates relate to C-capture 12, E-evaluation 14, R-redesign 16, T-target 18, I-implement 20, F-follow up 22, and the Y-yield or justification 24.

These templates are loaded into processor 10 and are filled out by a user 26, in one embodiment through a keyboard 28 to a template completion module 30 and then to processor 12.

The templates are displayed on a display or printer 32, with the filled out templates resulting in a complete evaluation and a thoroughly considered suggested course of action in order to improve a particular system, here shown at 34.

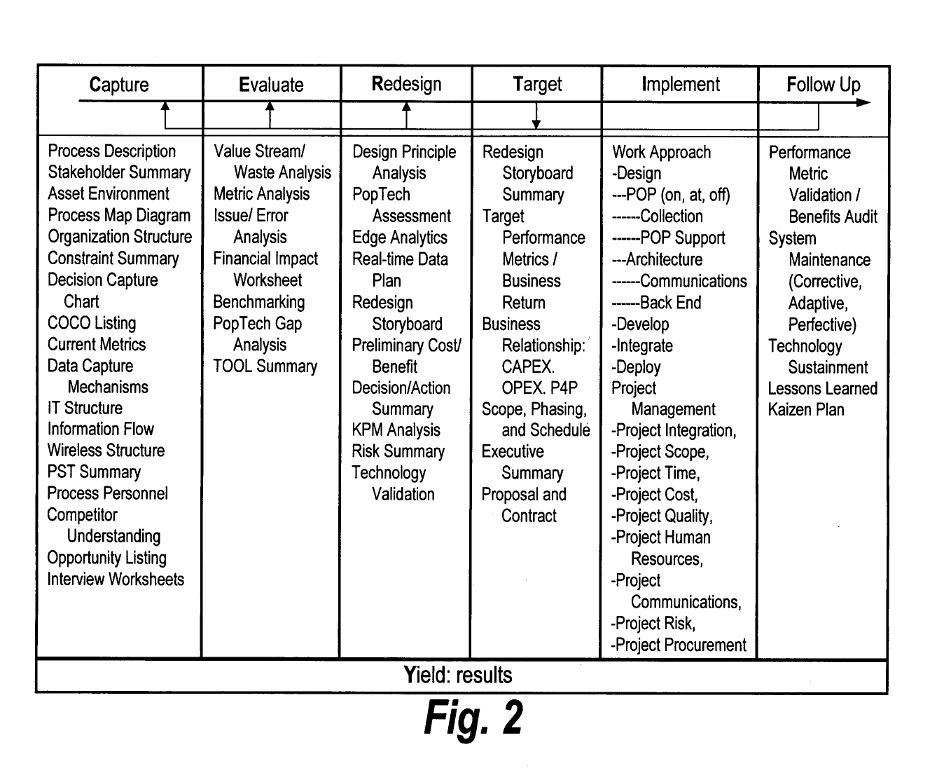

Referring now to FIG. 2, the templates utilized in the CERTIFY system include as shown the capture templates, the evaluate templates, the redesign templates, the target templates, the implementation templates and the follow-up templates as well as a template to prompt a determination of the yield of the newly designed system or the results.

As mentioned above, the “capture” prompts are intended to document the current or “as-is” processes. The subject system assists in the assessing of the potential benefits of a redesign effort, the ability to compare before and after performance, the ability to develop a strategy which will result in a transition between the before and after performance, while at the same time assessing the resources associated with the transition activity. The capture prompts are used to establish the foundation for the evaluation phase to identify targets of opportunity that warrants special attention in a redesign effort.

As to the “evaluation” prompts as mentioned before, the objective of the evaluation is to reach an understanding of the particular problems involved in the system as well as to be able to embark on a redesign effort.

As mentioned above the “redesign” effort centers around templates that result in the prompting of creative thinking to eliminate or reduce identified issues and to apply various technologies to enable the desired end results.

The “targeting” prompts have a goal to jointly assess the results of the capture, evaluate and redesign stages and to permit individuals to agree on the next steps to be taken. Once there is agreement, the targeted project is articulated. Also needed, in terms of joint concurrence before proceeding, is a project delivery approach. There are business models including CAPEX (capital expense), OPEX (operating expense) and P4P (pay for performance) that focus the project delivery approach. The final step of the targeting prompts is to prompt individuals to detail the aspects of the anticipated project into a concise proposal that conveys the essence of the agreed upon target.

In the “implementation” prompts one must take very seriously the management of the implementation phase of any project. In order to do so, one is prompted to look at the detail, design and development required, the system delivery required, and the project management control of the undertaking.

Project management control covers a communications plan, a work breakdown structure, roles and responsibilities, a resource plan, a procurement plan, a quality plan, a project schedule, a project budget, a change management plan and an implementation checklist.

It is noted that meticulous project planning is instrumental to the success of the CERTIFY effort. Of particular importance is system delivery. System installation and delivery is more than simply installing the enabling technology. It also involves a careful migration strategy to minimize disruption to operations. It involves hardware and software installation and verification of the planned functionality, including final system level testing. It also includes delivery of system documentation, completing the customer training, establishing feedback systems and maintenance procedures. Note, it is imperative to prompt individuals to document a basis for process improvement and current assessment, so that the process improvement and assessment are institutionalized at this time.

Follow-up prompts are also extremely important. The commitment to improving a system does not stop with project installation. At defined intervals, individuals are prompted to meet and assess the results, the successes, the challenges and the plans for the future. Sustainment and maintenance are quite often the biggest point of failure for a project. Follow-up prompts are intended to not only sustain but to institutionalize a continuous improvement system that takes advantage of all the capabilities of a high performance organization.

Finally, the yield of the entire process is to be ascertained in terms of documenting the results, both in terms of measurable improvements and in terms of cost savings.

As will be described in the following Figures involving templates, the capture prompts include process description, a stakeholder summary, the asset environment, process map diagrams, organizational structures, constraint summaries, decision capture charts, a so-called COCO listing, meaning a listing of the chain of custody operations, current metrics, data capture mechanisms, IT structure, information flow, wireless structure, PST or performance support technologies, process personnel, competitor understanding, opportunity listings and interview documentation. By having prompts to generate these inputs, the capture portion of the CERTIFY system is completely achieved.

With respect to the evaluation prompts, values stream and waste analysis prompts are called for, as well as metric analysis, issue and error analysis, financial impact in the form of a worksheet, benchmarking, and PopTech Gap analysis where PopTech Gap refers to the point of performance technical assessment for technology gaps. Also, TOOL or target of opportunity listings are important in the evaluation portion, in which the TOOL summary incorporates the targets of opportunity listings.

With respect to the redesign prompts, there is a design principal analysis prompt, a POPTECH assessment prompt, an analytics prompt, a realtime data plan prompt, a redesign storyboard prompt, a preliminary cost and benefit prompt, a decision and action summary prompt, and a KPM analysis prompt, in which KPM refers to key performance metrics. Moreover, there is a risk summary prompt and a technology evaluation prompt.

With respect to the target prompts, a redesign prompt includes prompting for storyboarding and summaries, and a target prompt includes prompts for performance, metrics, and business return. The target prompts also include business relationships, capital expense or CAPEX analysis, an OPEX or operating expense analysis and/or a prompt for a P4P or pay for performance analysis. Also in the target prompts are scope prompts, phasing prompts and schedule prompts, as well as executive summary prompts and proposal and contract prompts.

With respect to the implement prompts, there are prompts for a work approach including design, point of performance, on, at and off prompts, a collection prompt, a point of performance prompt, and architecture prompts including communications prompts and backend prompts. Moreover in the implement prompt section there are development prompts, integrate prompts, deploy prompts and project management prompts, as well as project integration prompts, project scope prompts, project time prompts, project cost prompts, project quality prompts, project human resources prompts, project communications prompts, project risk prompts and project performance prompts.

Finally, with respect to follow-up prompts, there are performance prompts involving metric prompts and validation and benefits audit performance prompts, along with prompts for system maintenance, including prompts for corrective adaptive and perfective maintenance strategies, a technology sustainment prompt, a lessons learned prompt and a prompt to engage in a Kaizen plan which is a Japanese quality management program and technique.

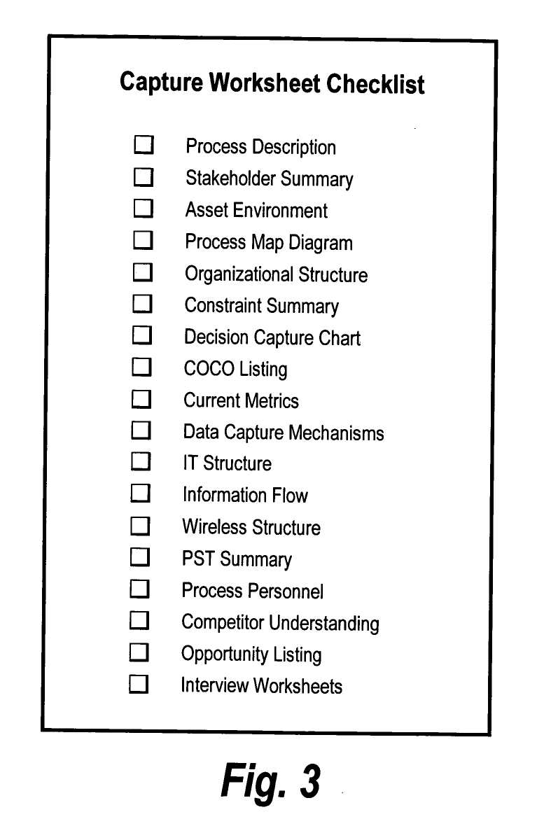

Referring to FIG. 3, the capture worksheet checklist prompts are as listed and is also summarized in FIG. 2.

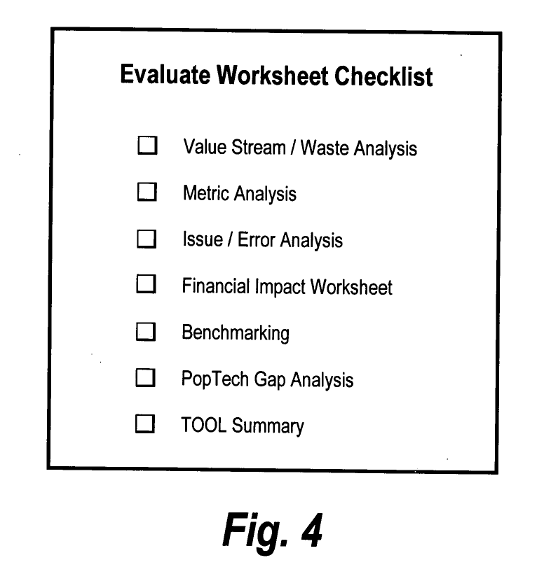

Referring to FIG. 4, as to the evaluate worksheet checklist prompts, these prompts are also as listed in FIG. 2.

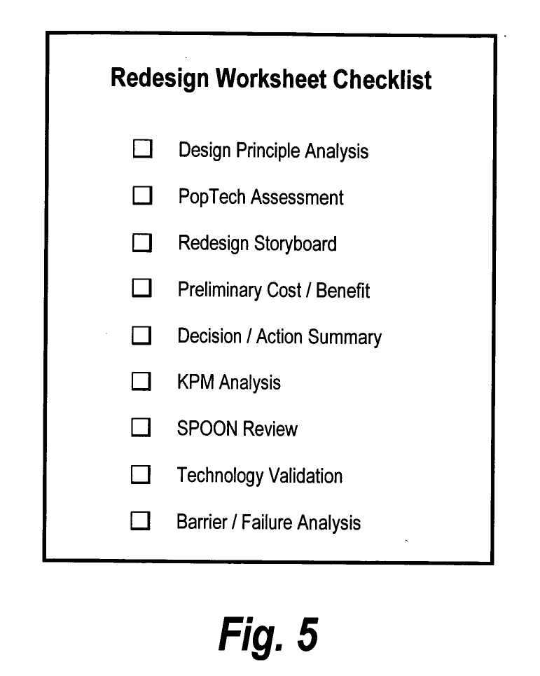

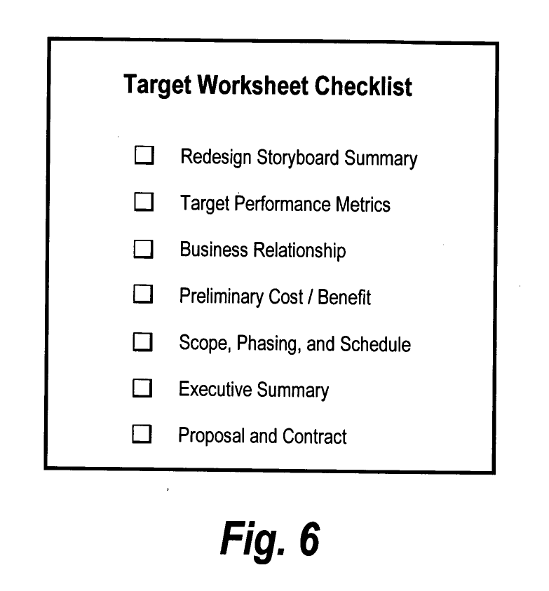

Referring to FIG. 5 the redesign worksheet checklist prompts are as described in FIG. 2. Referring to FIG. 6 the target worksheet checklist prompts are also described in connection with FIG. 2.

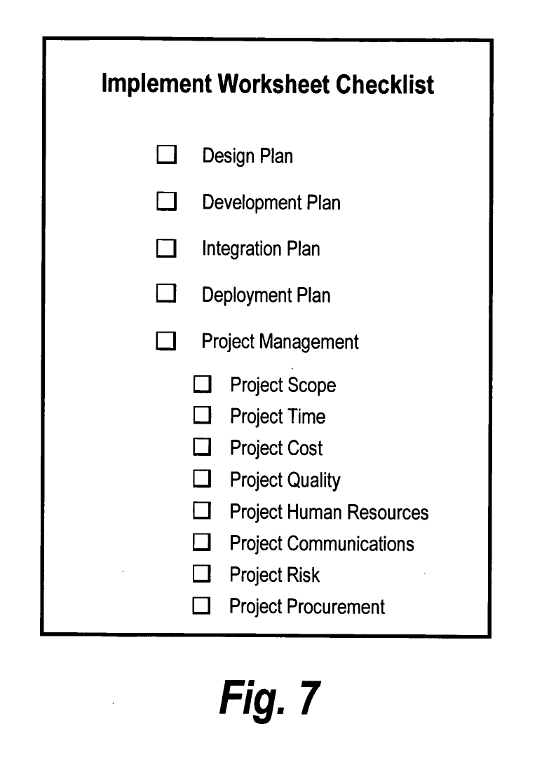

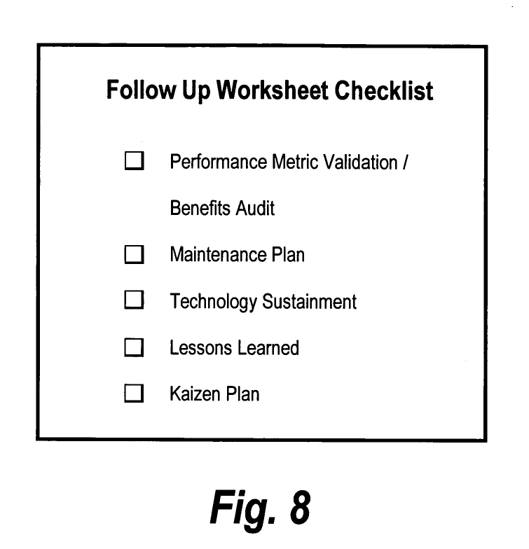

Referring to FIG. 7, the implement worksheet checklist prompts are as described in FIG. 2 and finally in FIG. 8 the follow-up worksheet checklist prompts are also described in FIG. 2.

It will be appreciated that the prompts are provided by templates which prompt an individual to fill in the data required in the templates by thinking about what the individual is prompted to consider.

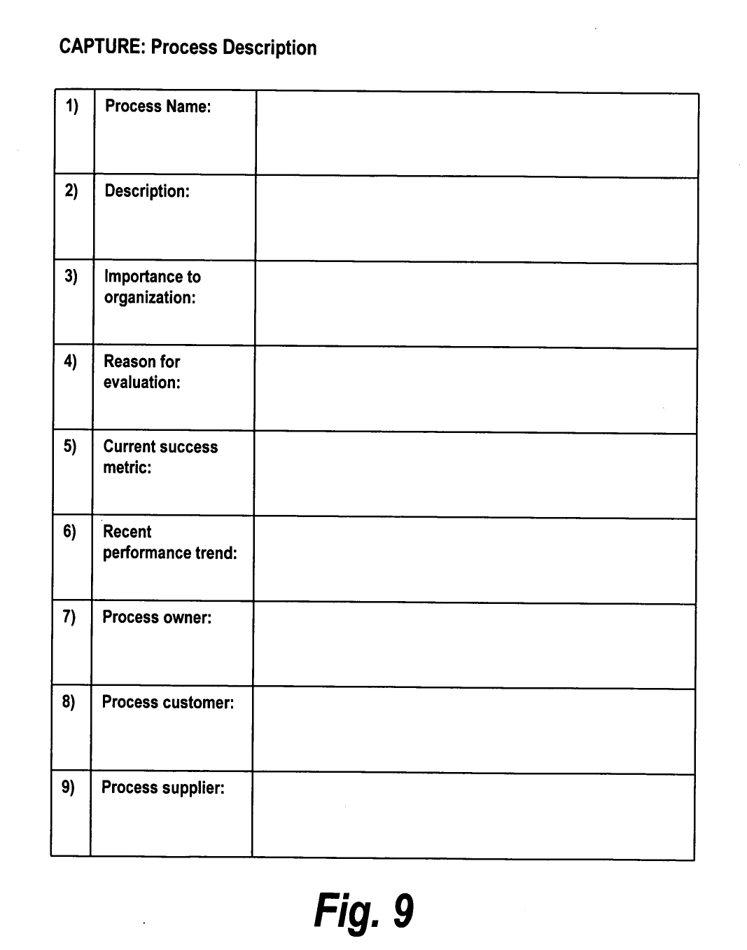

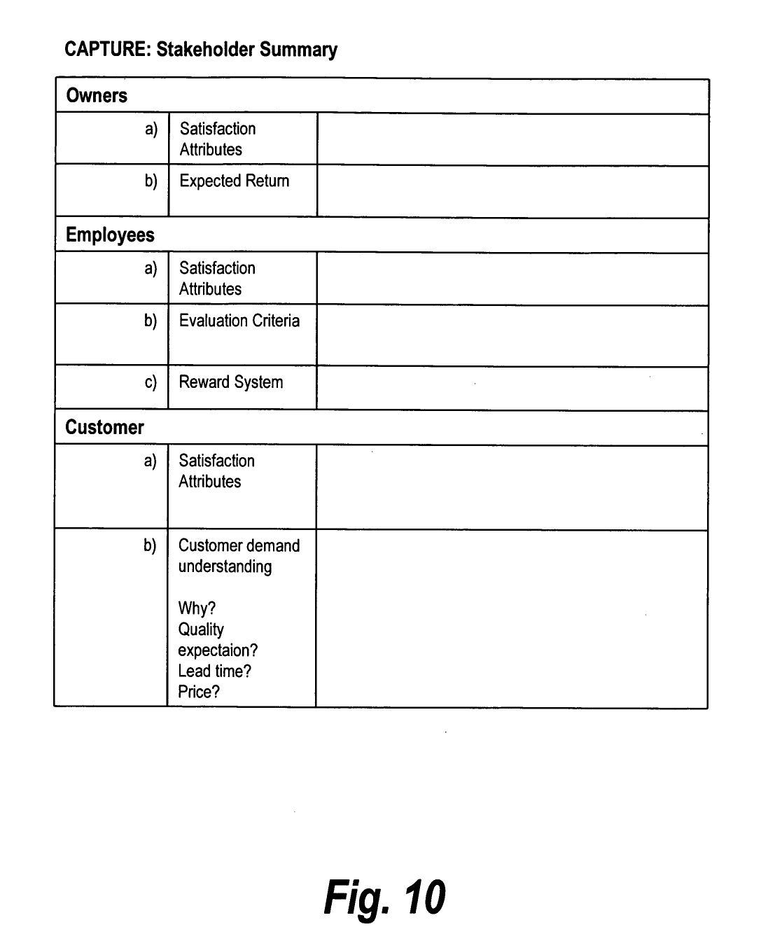

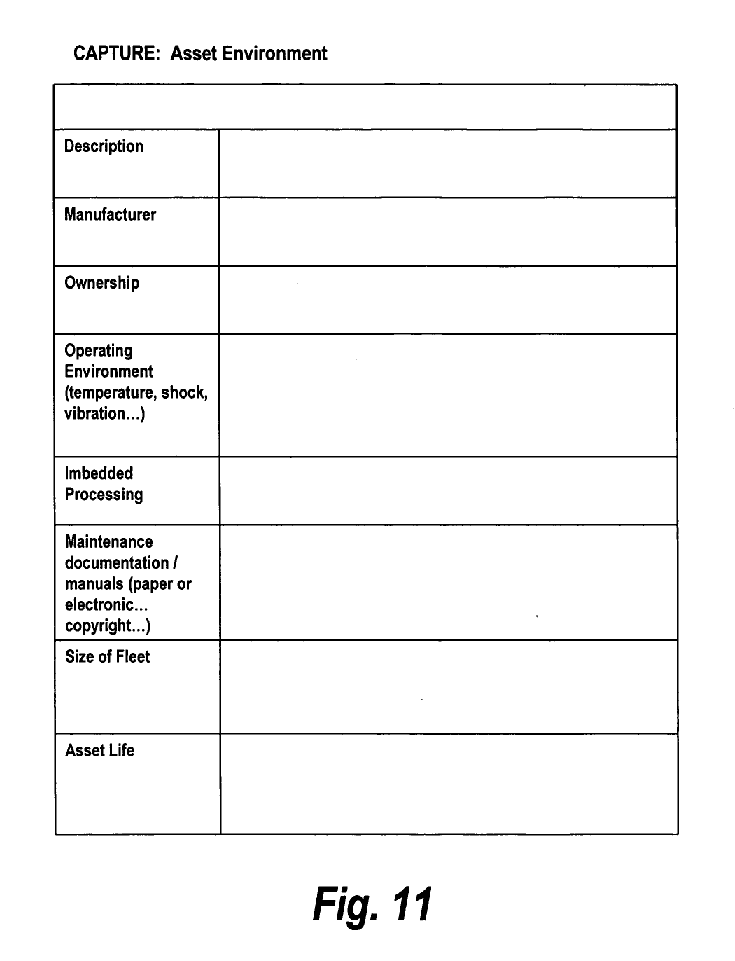

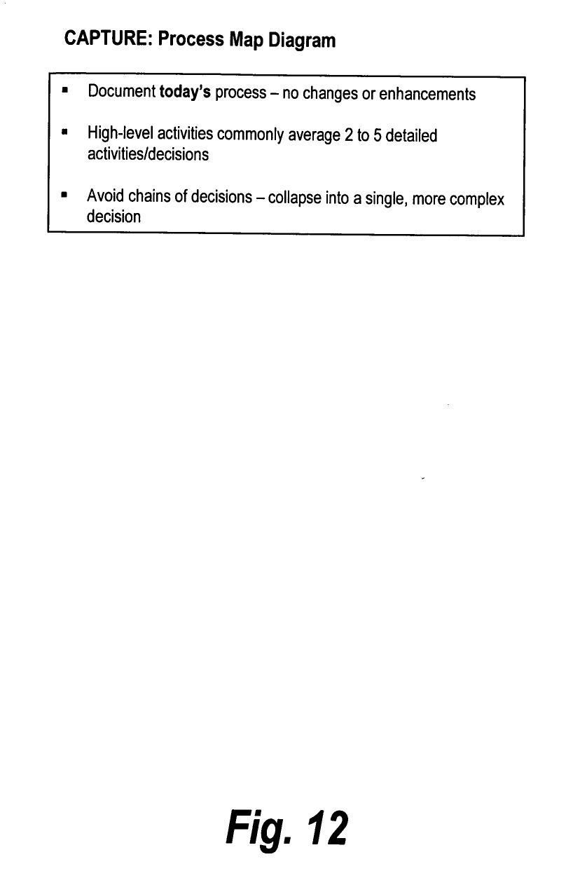

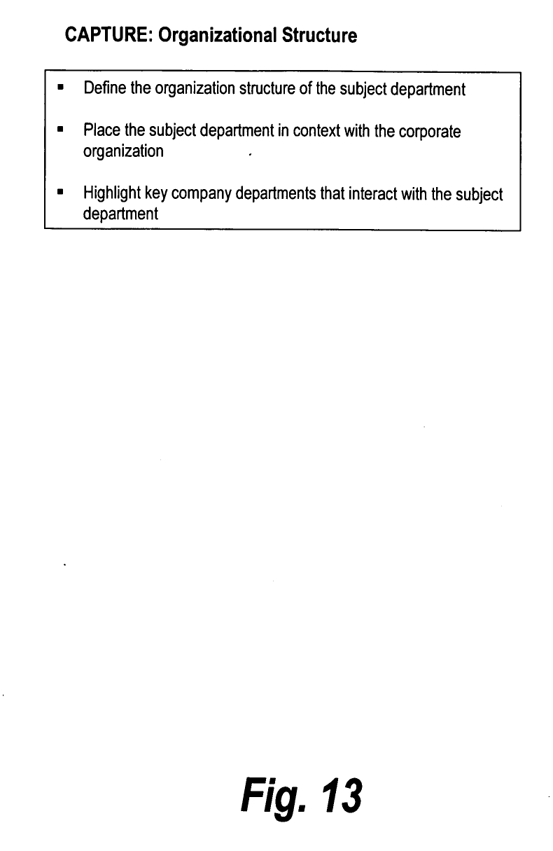

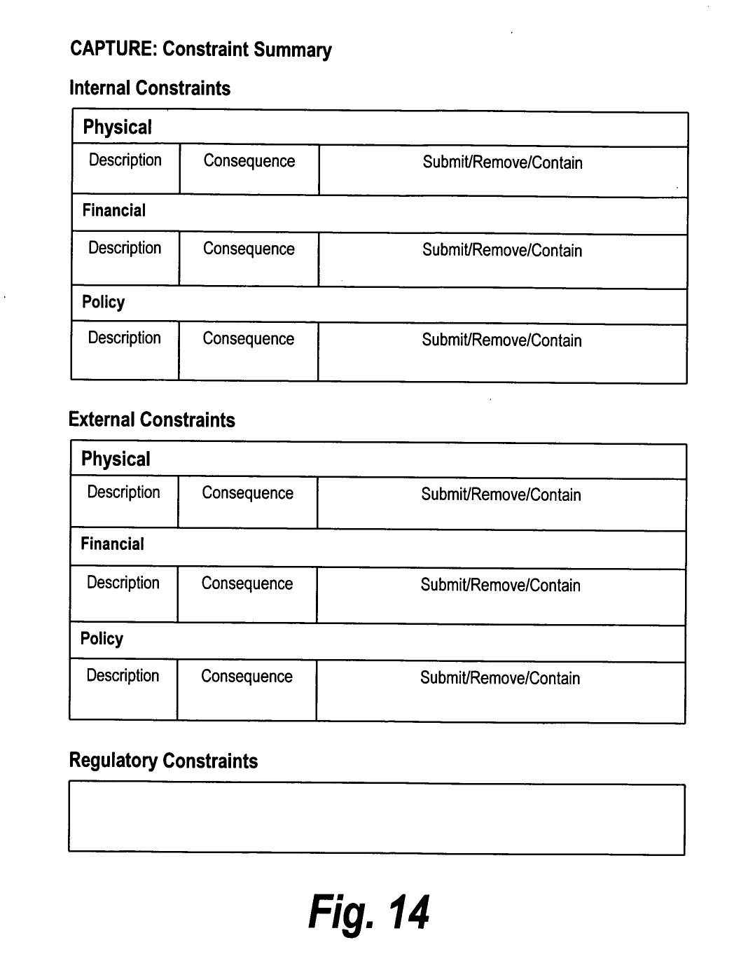

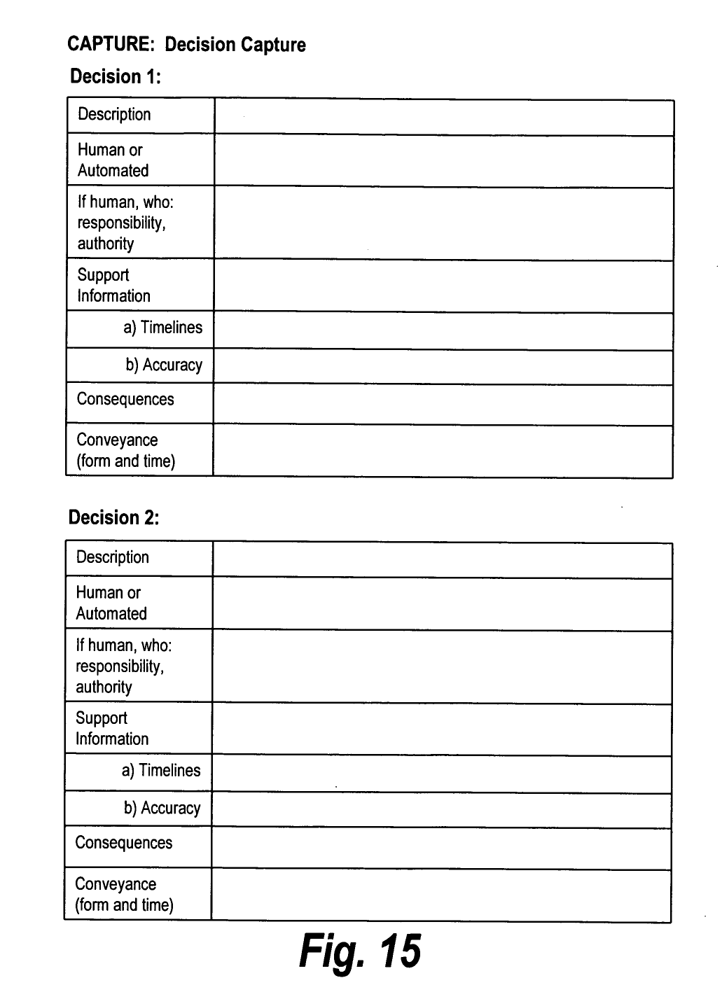

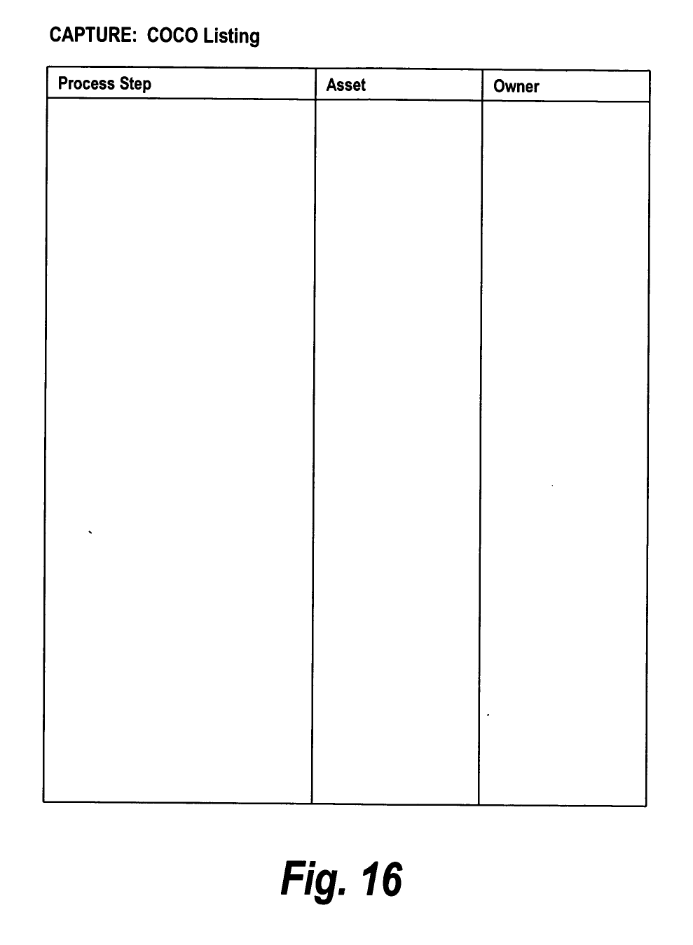

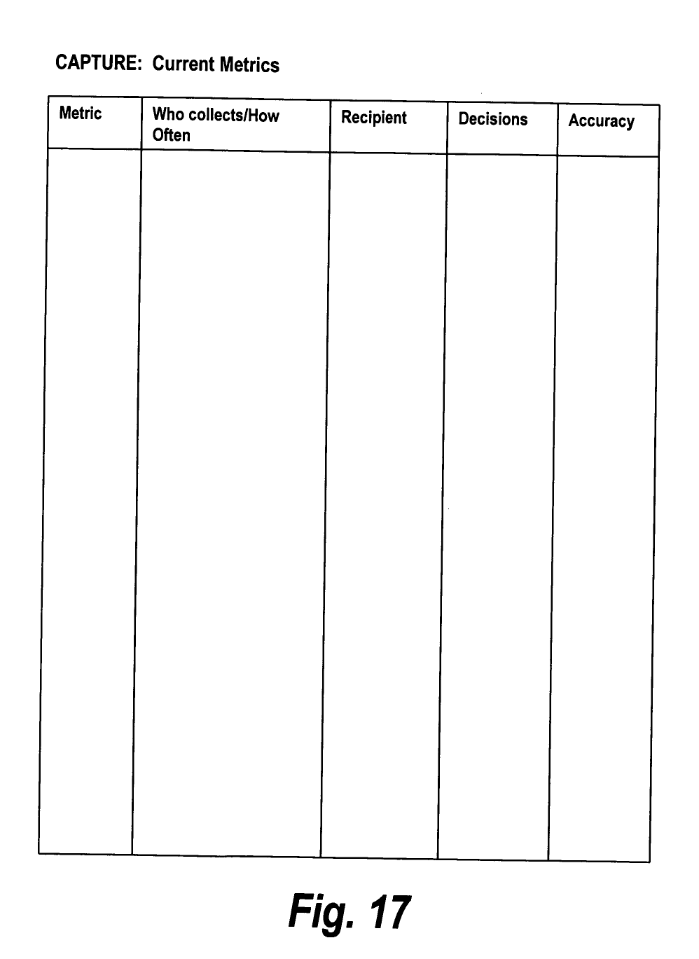

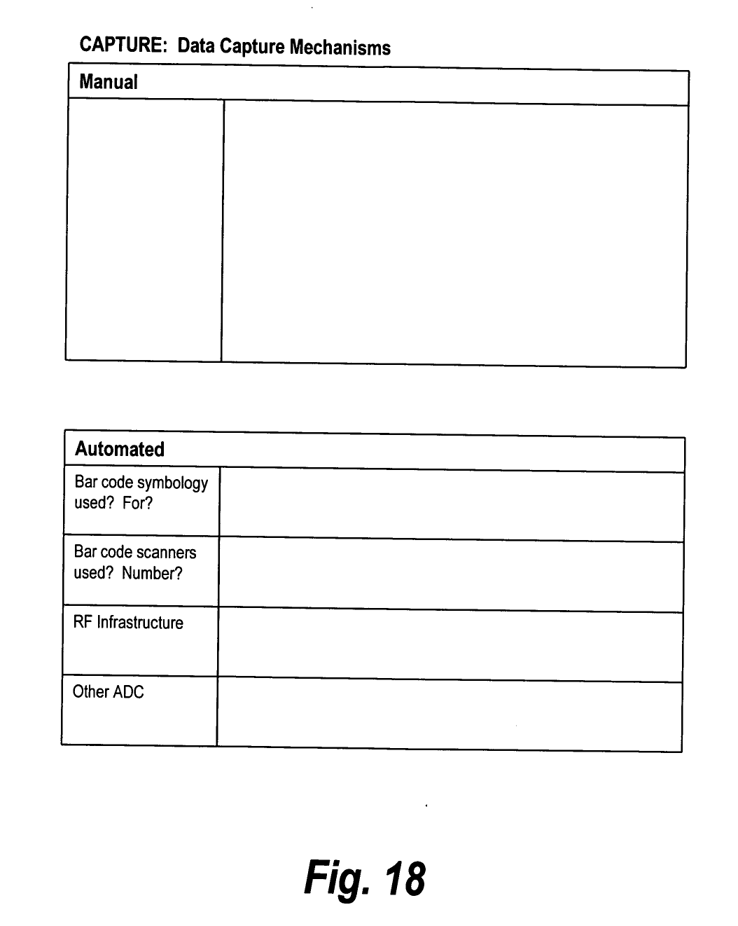

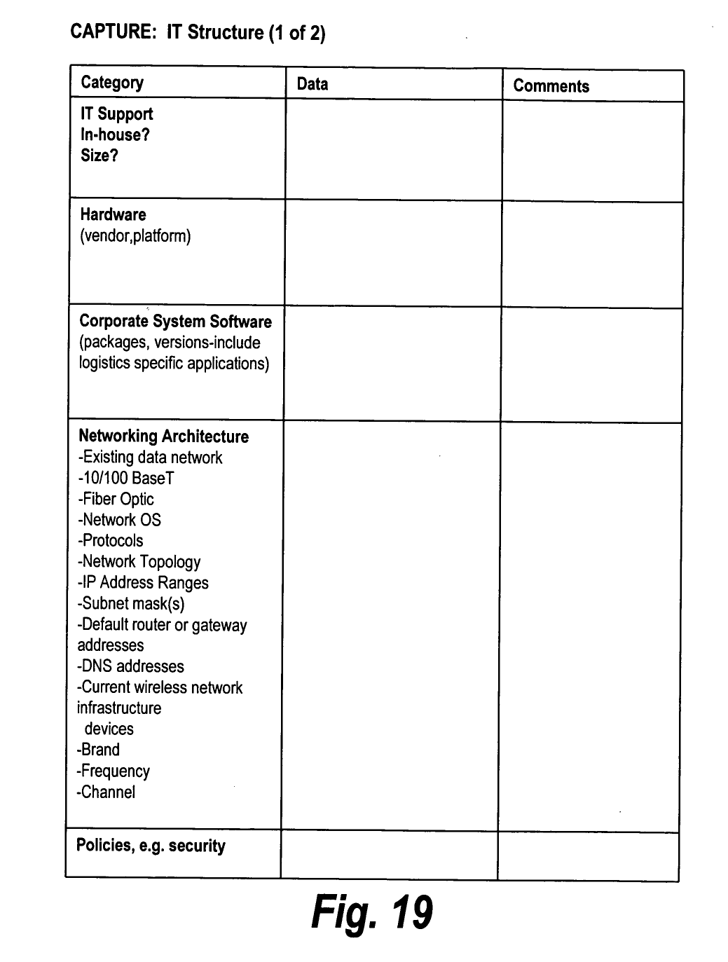

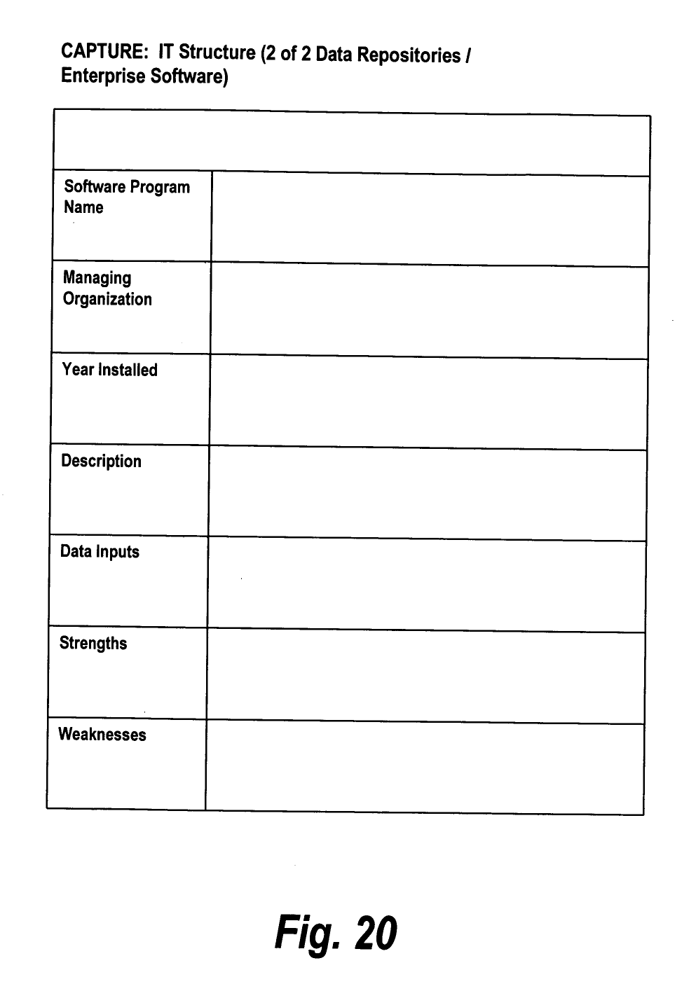

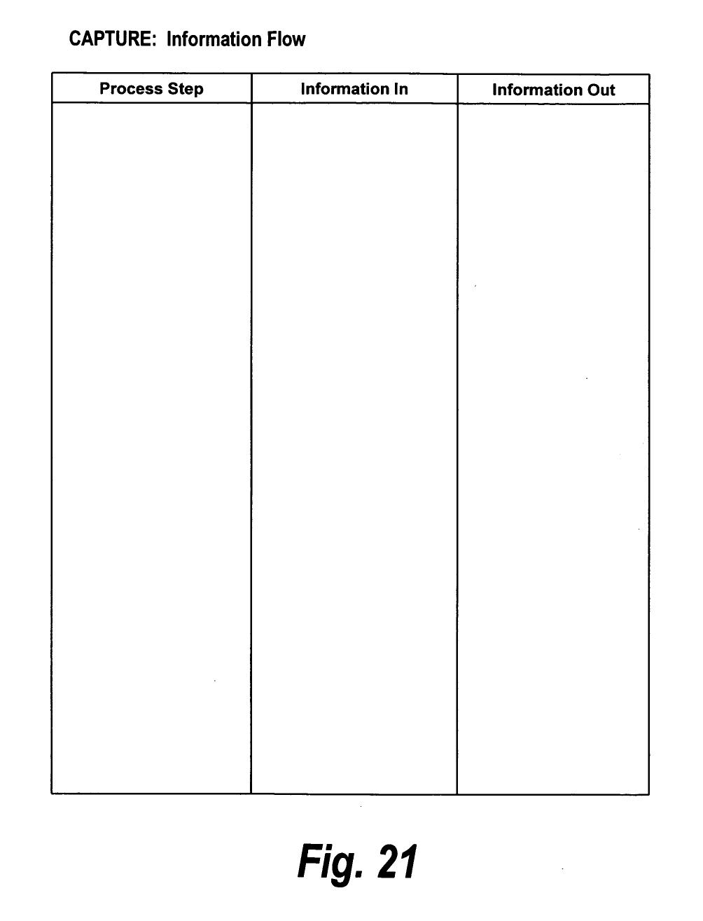

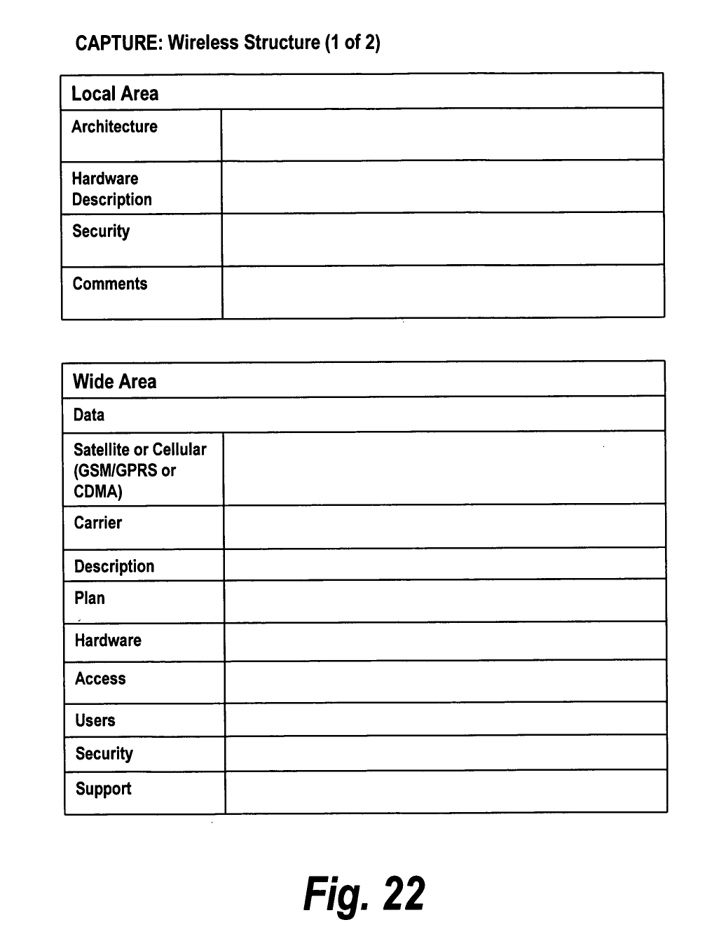

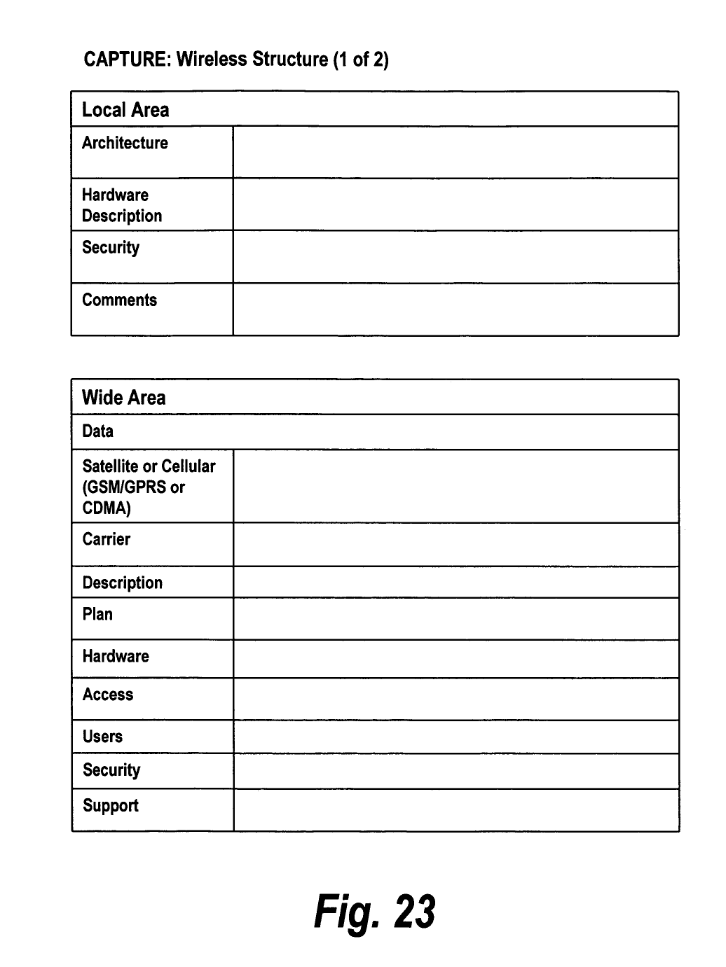

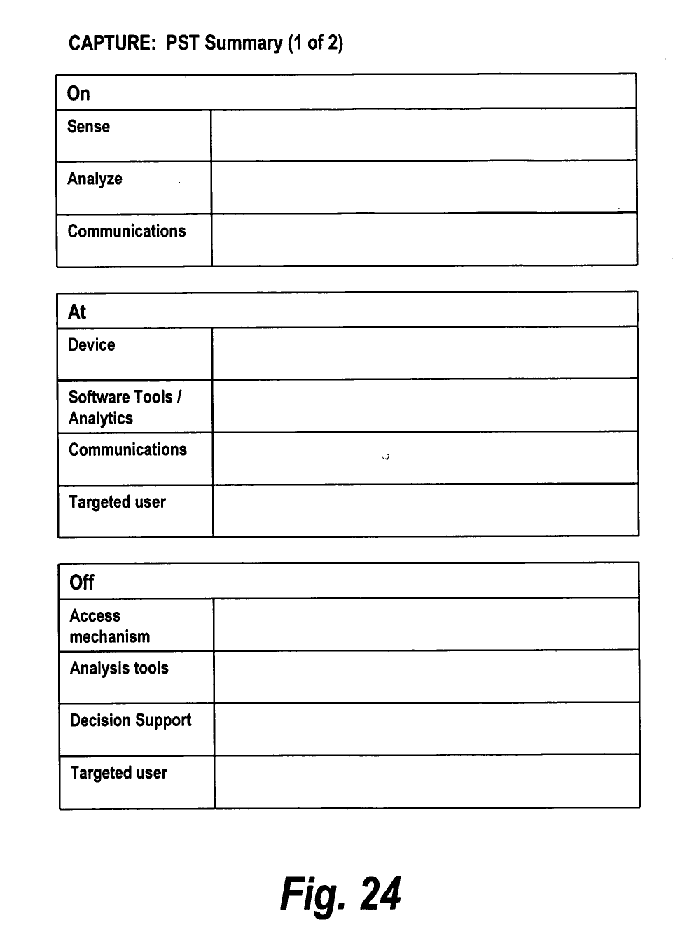

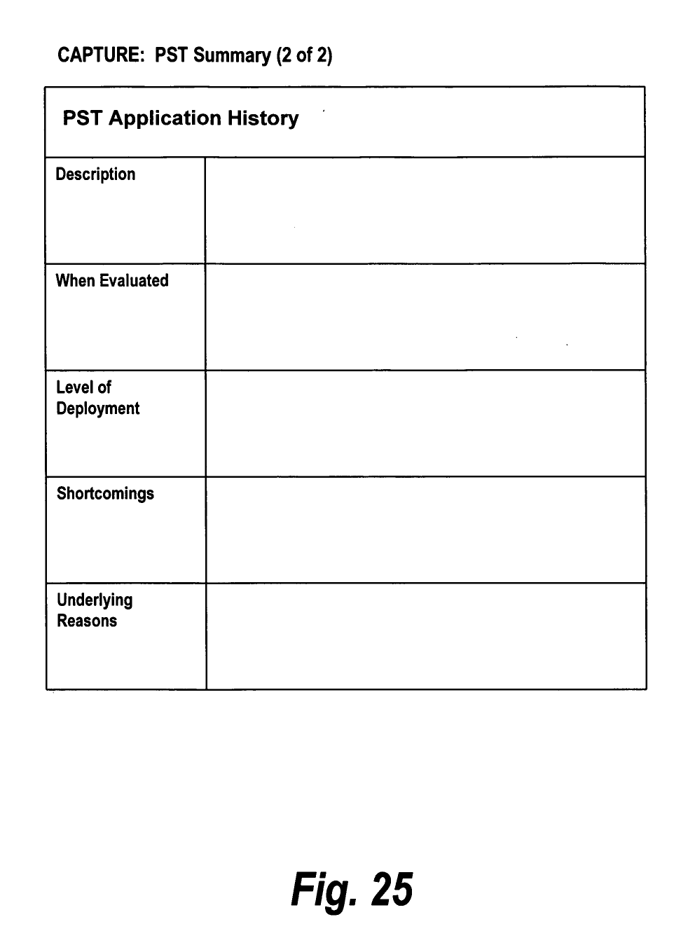

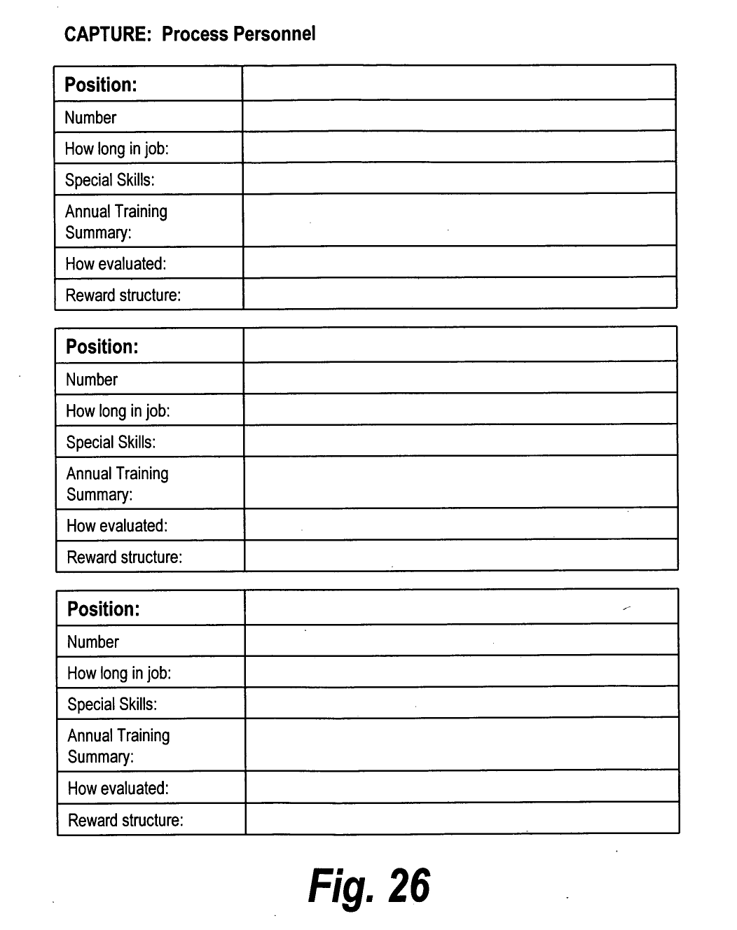

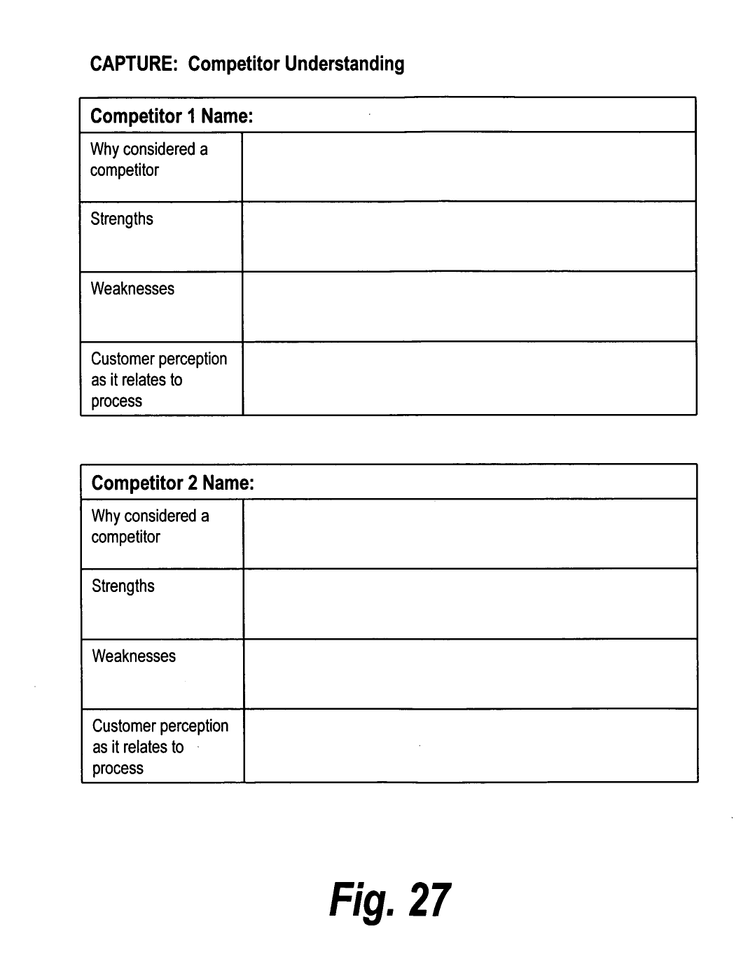

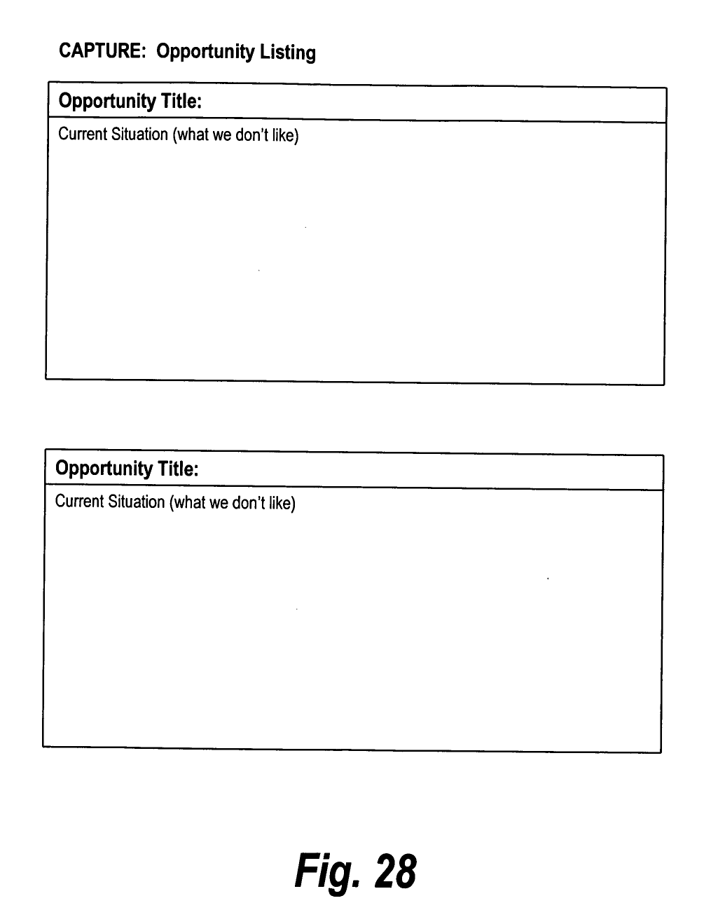

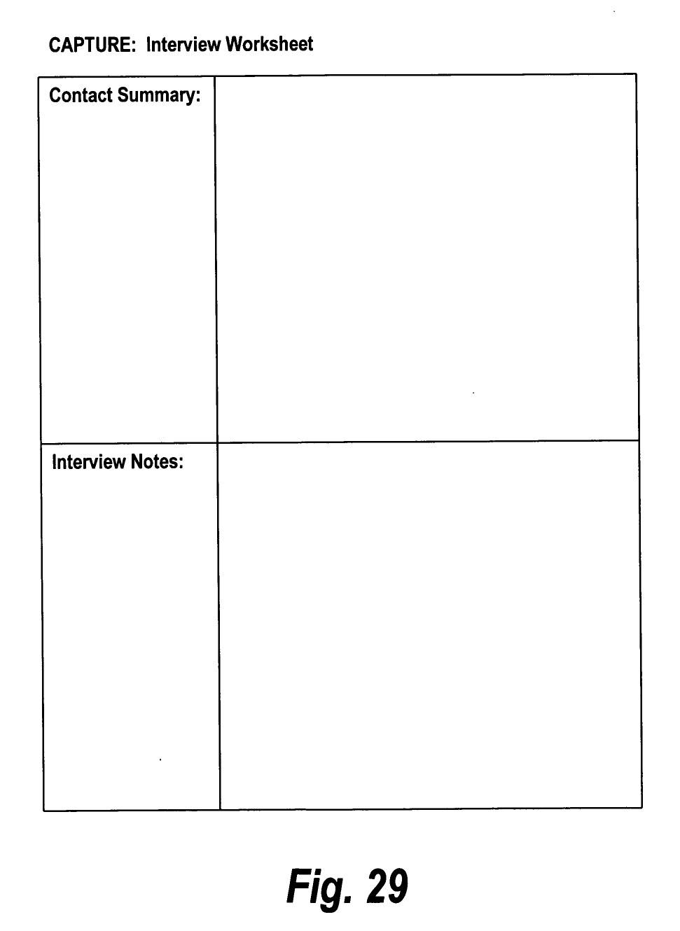

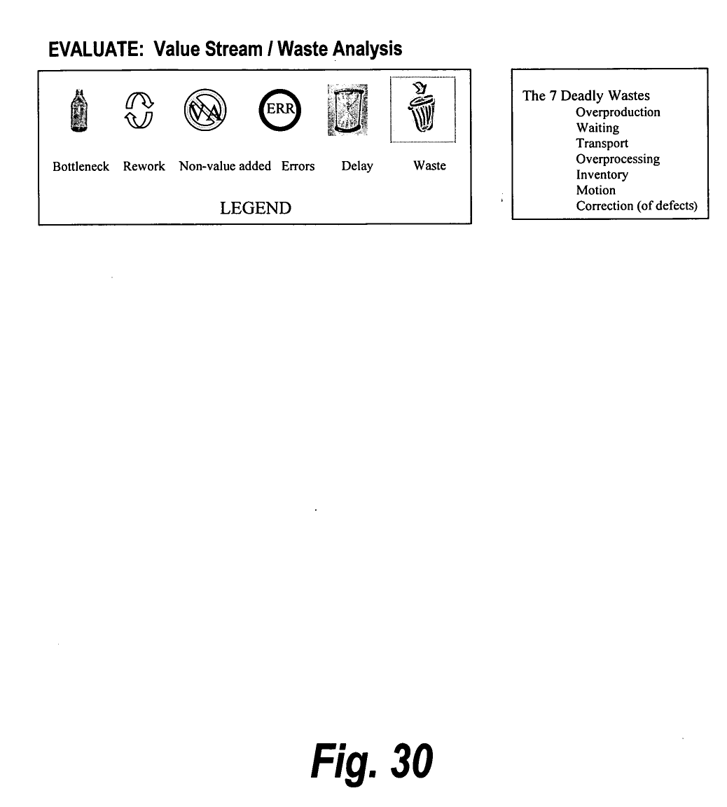

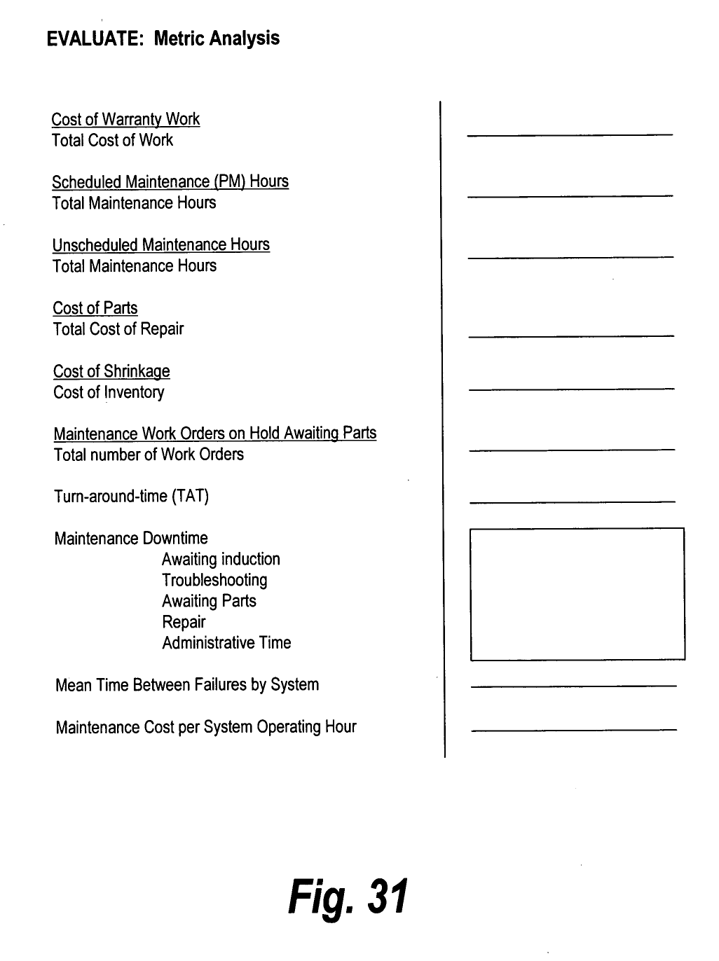

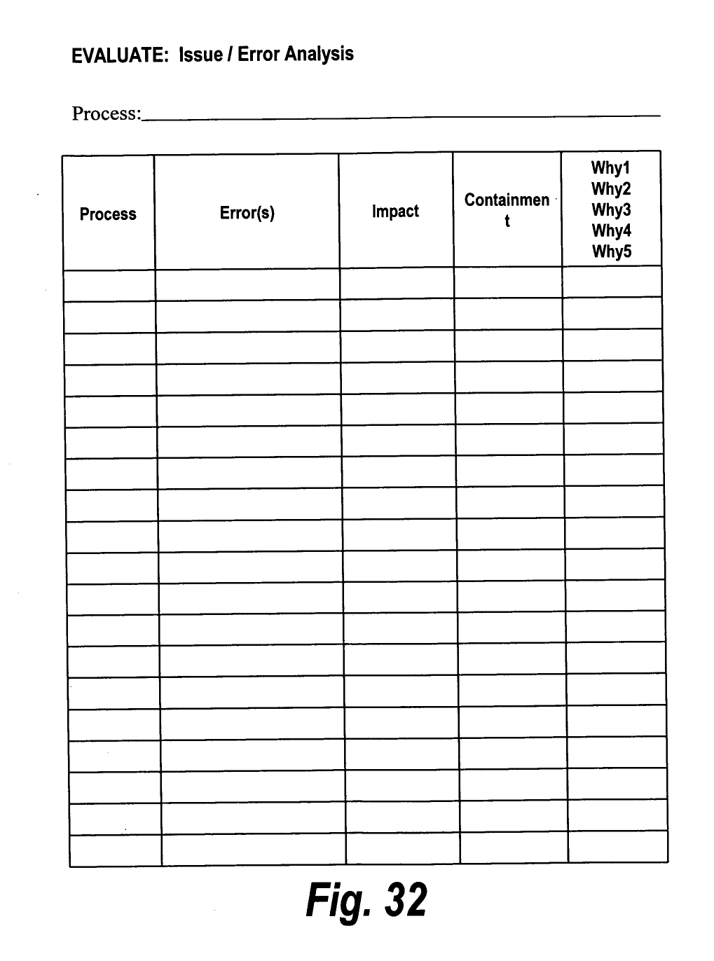

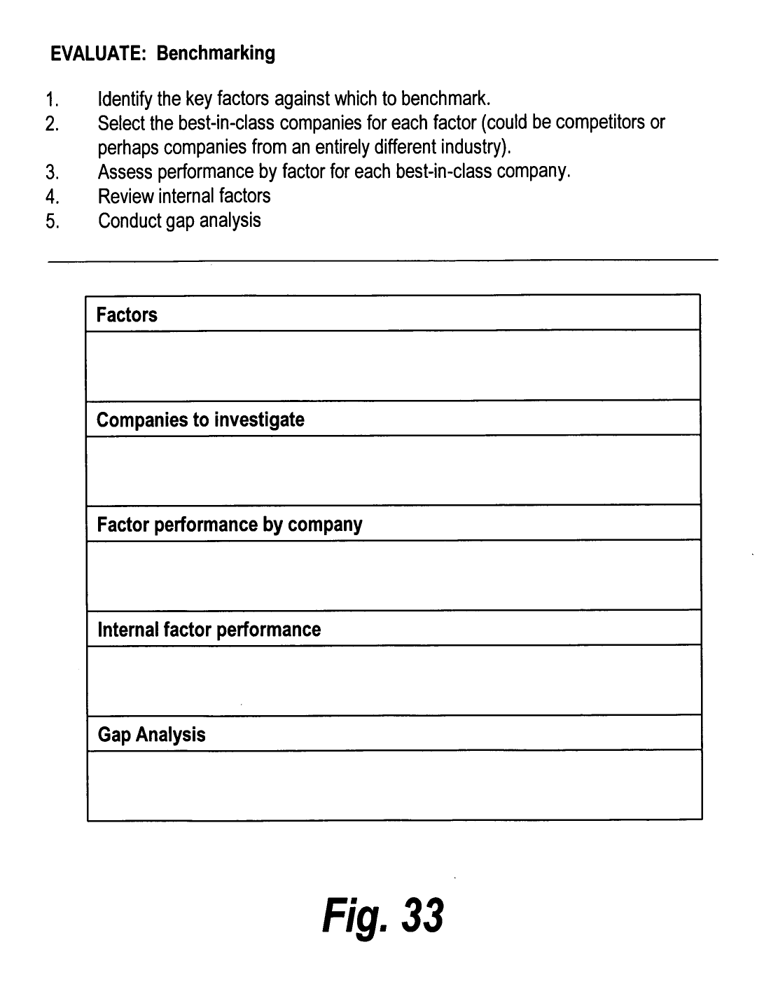

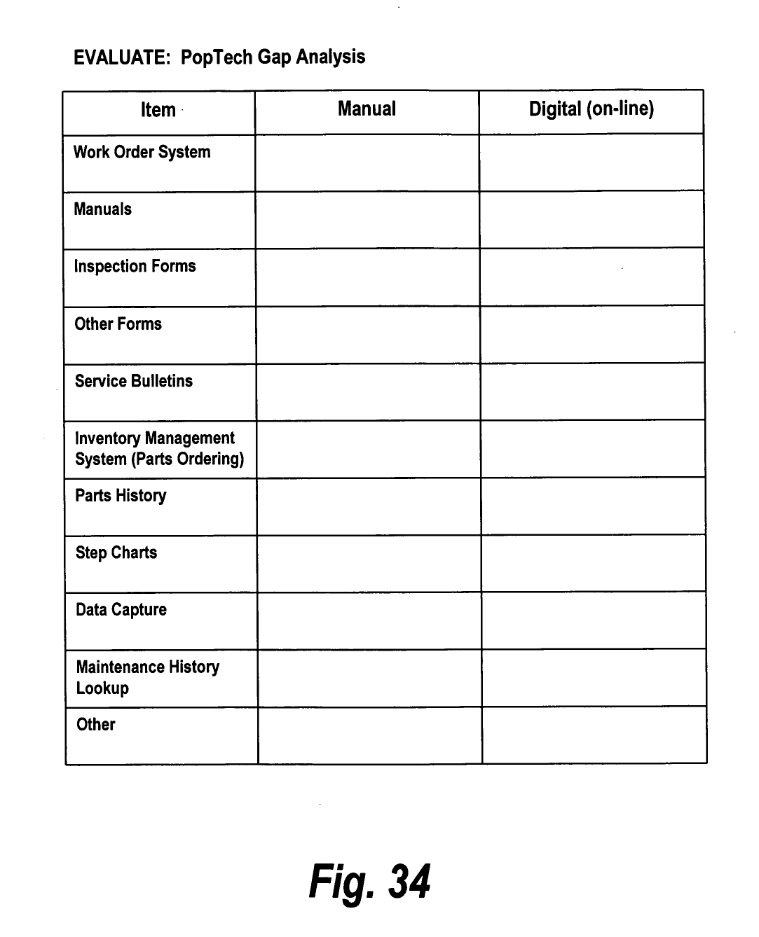

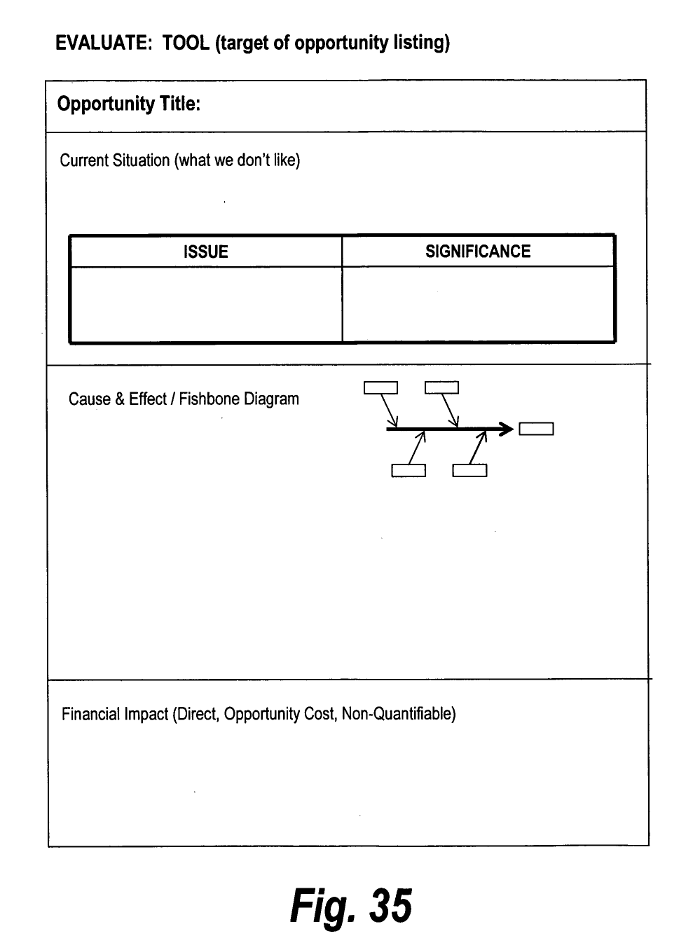

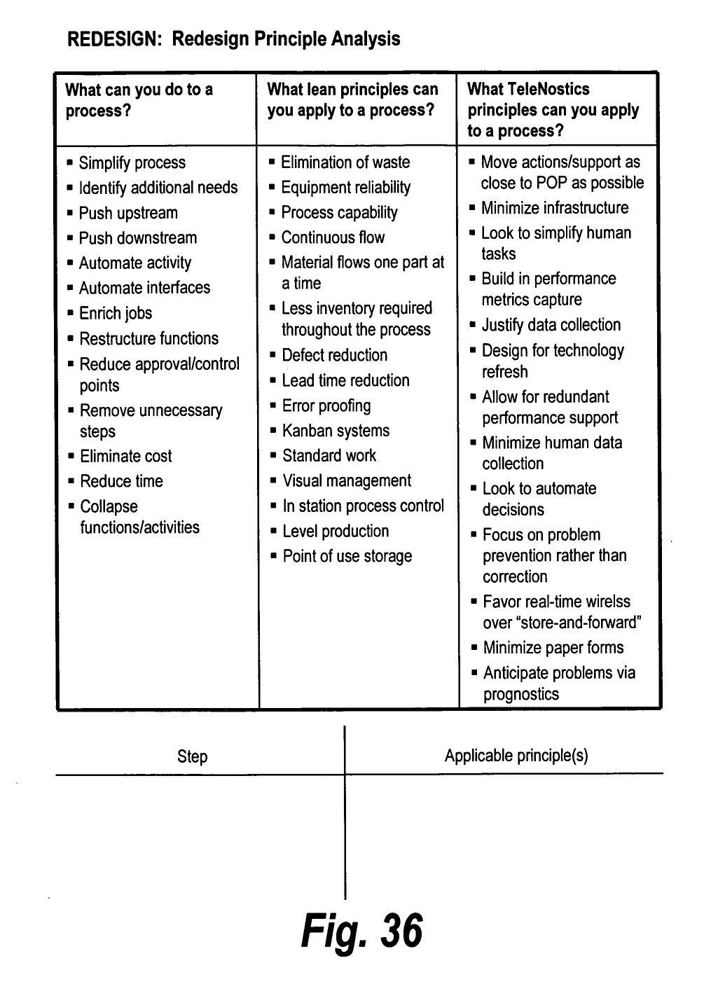

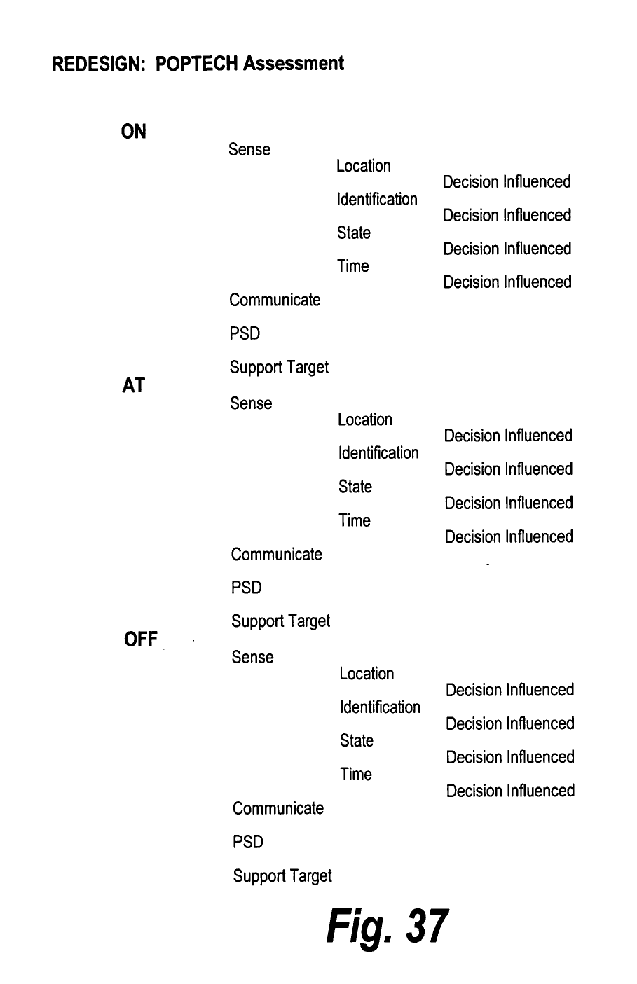

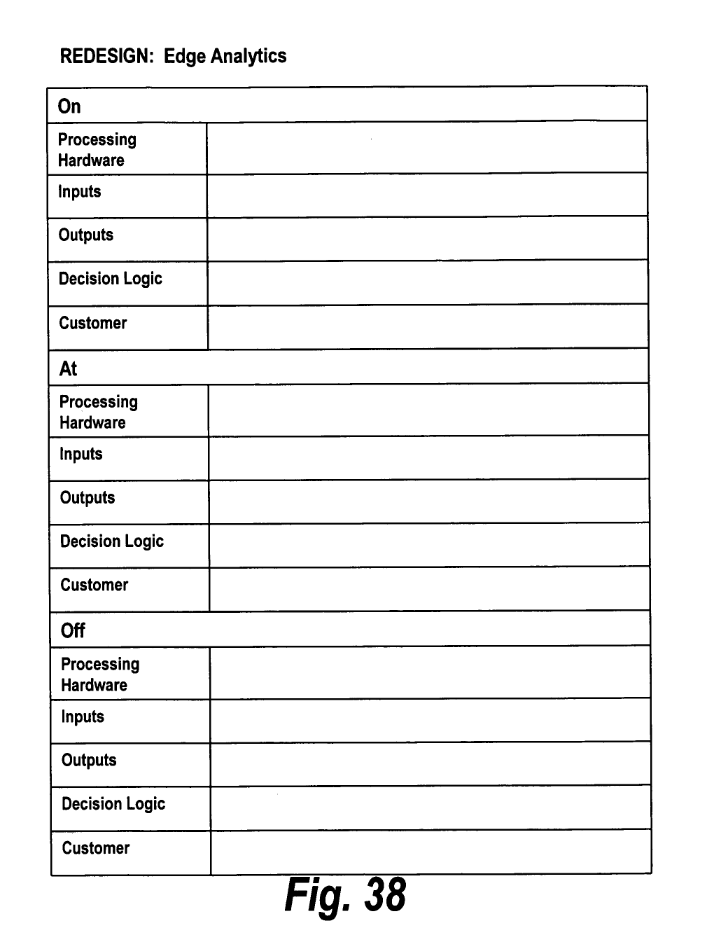

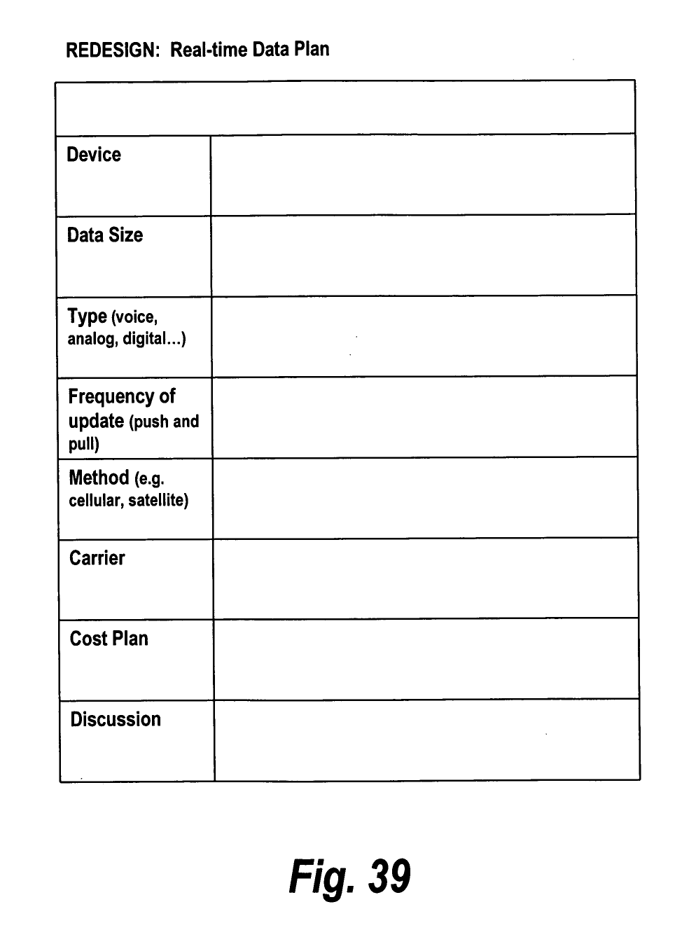

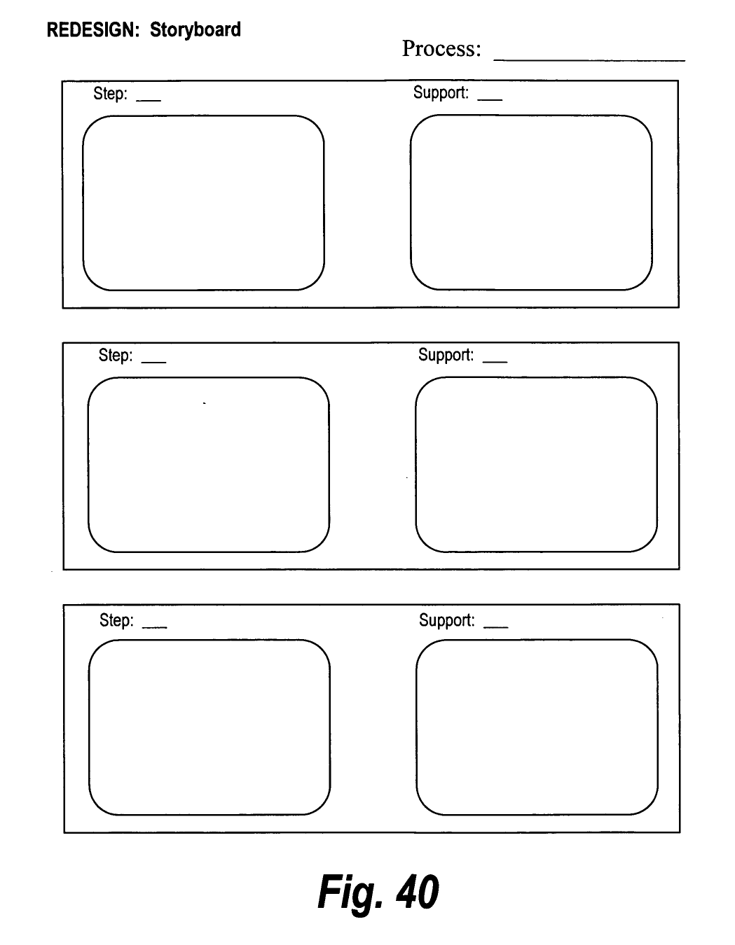

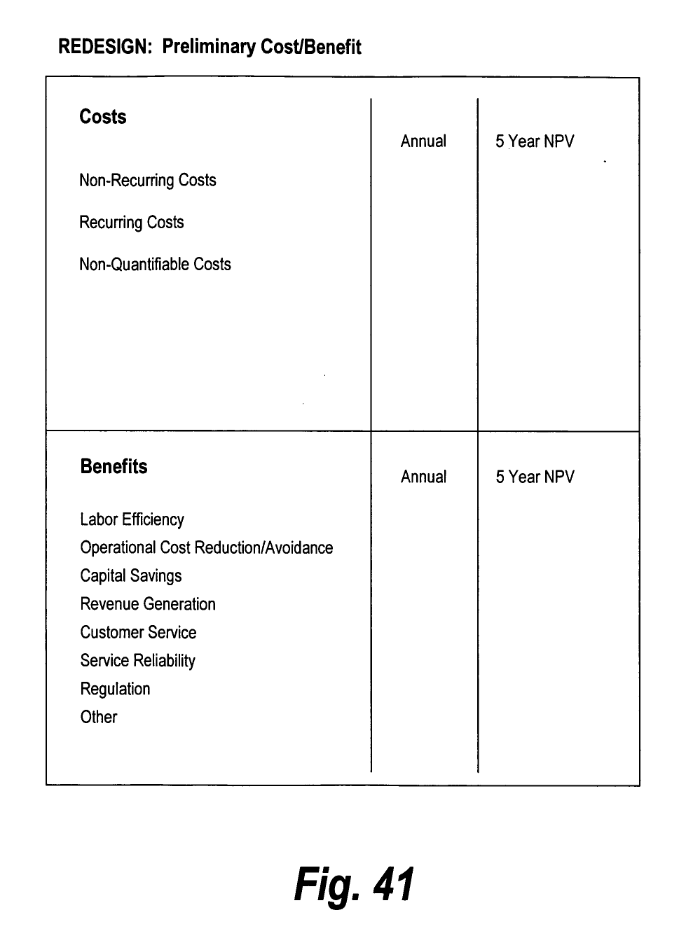

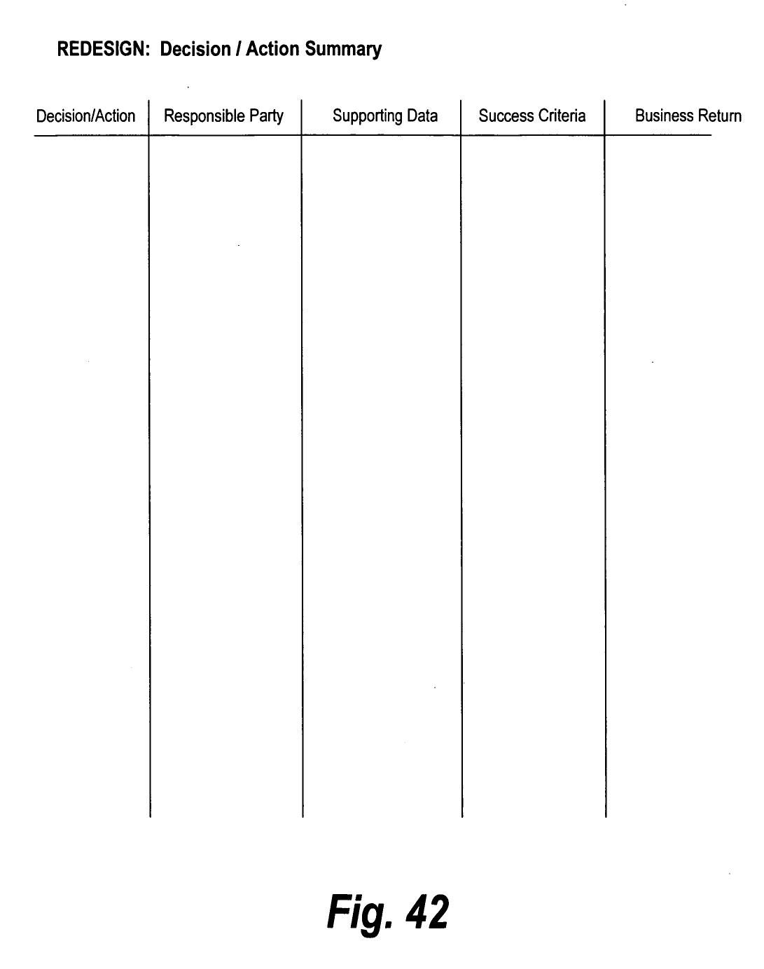

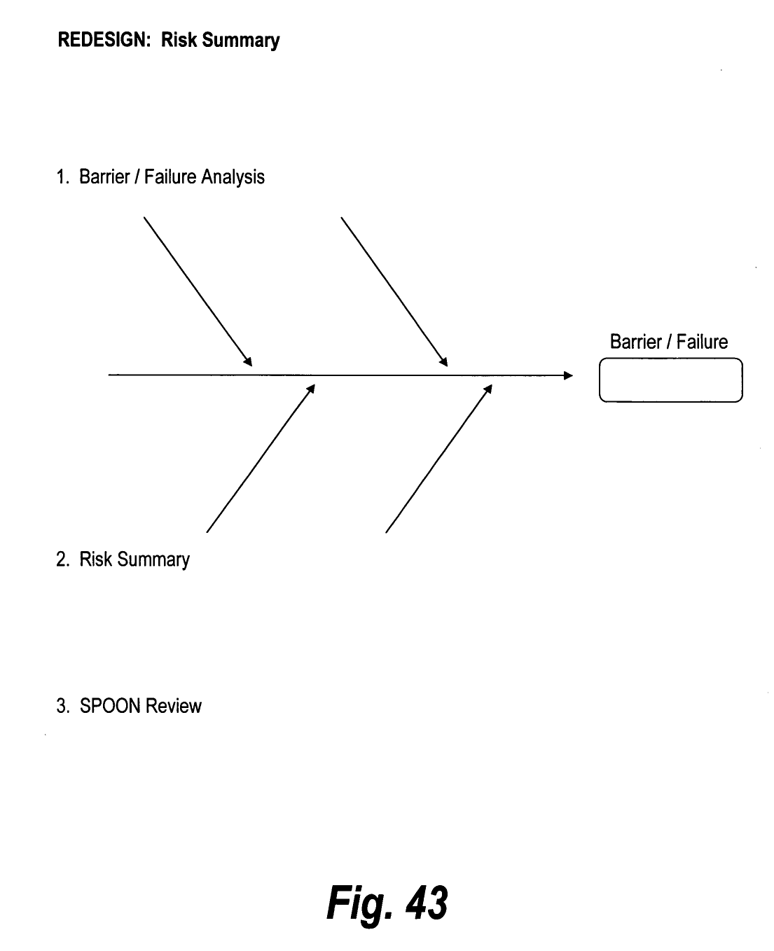

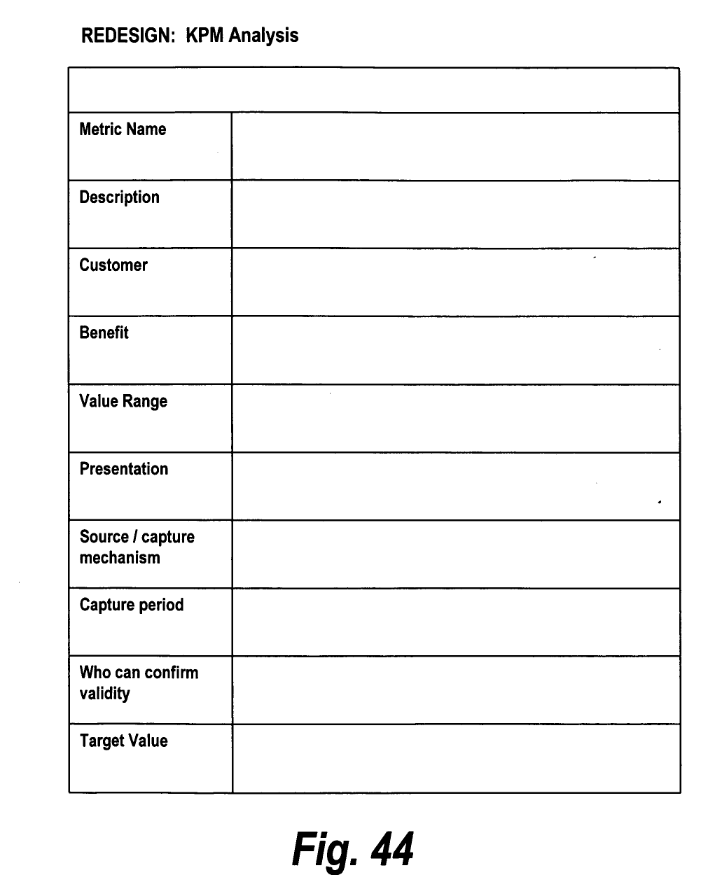

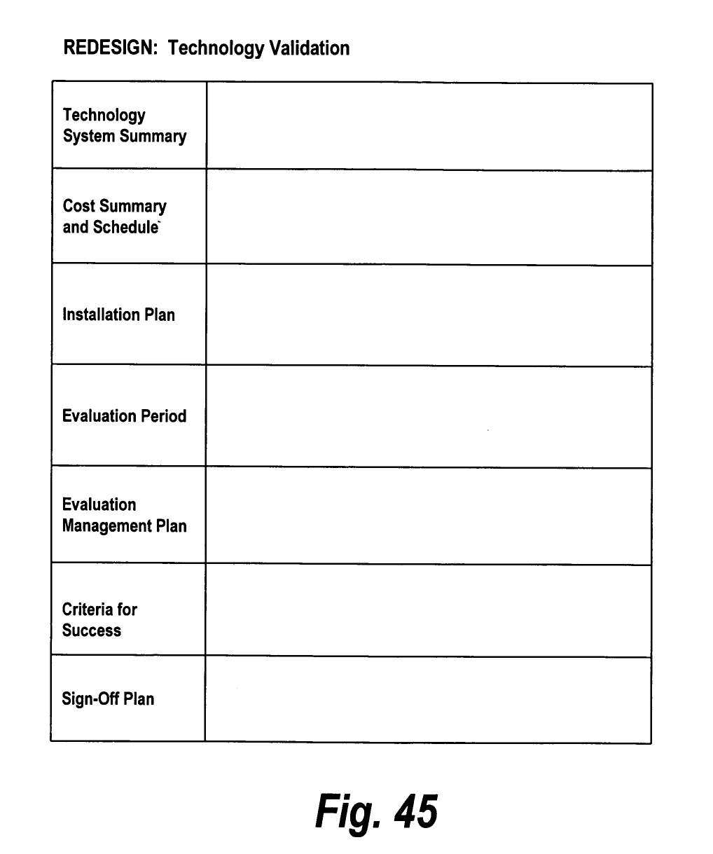

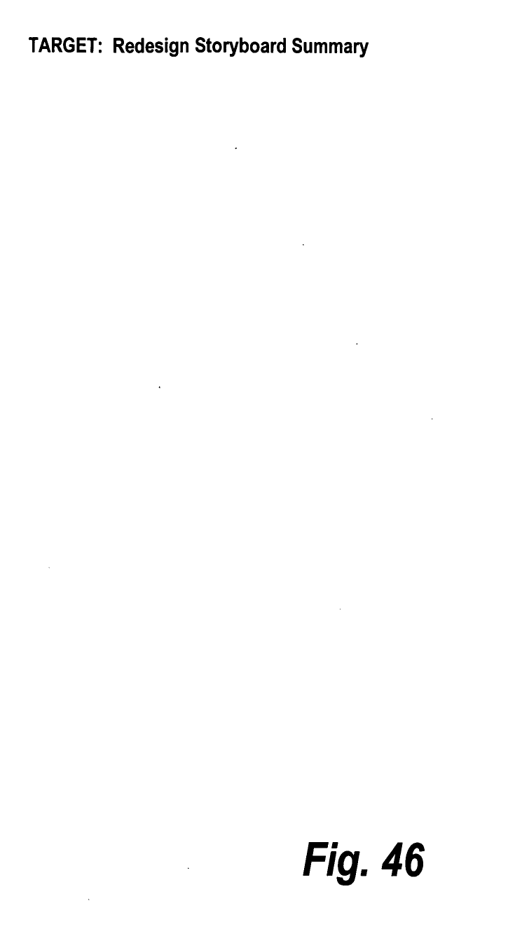

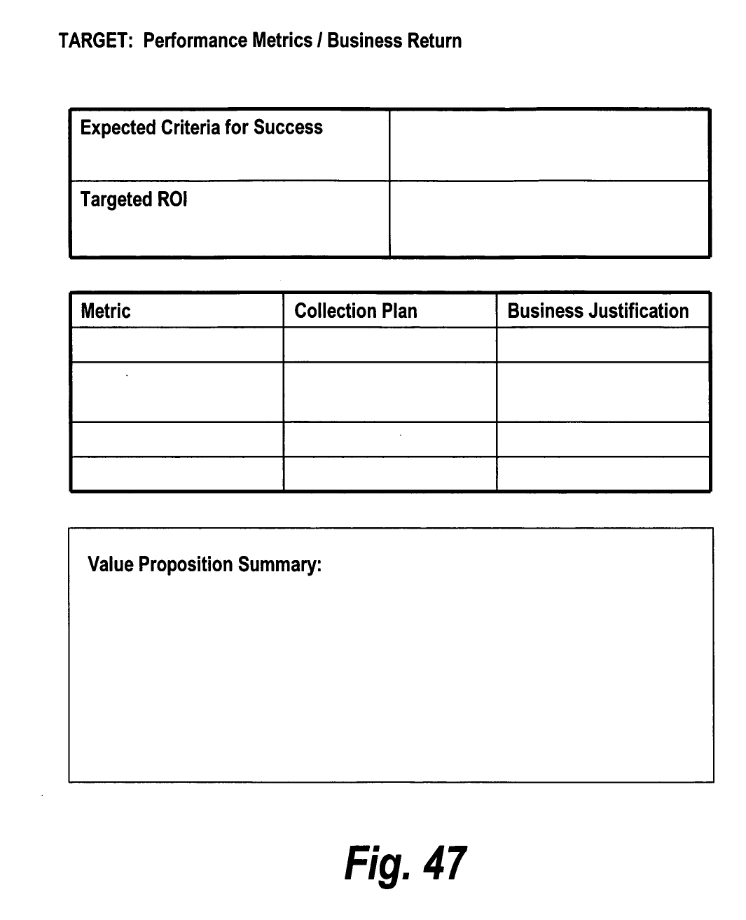

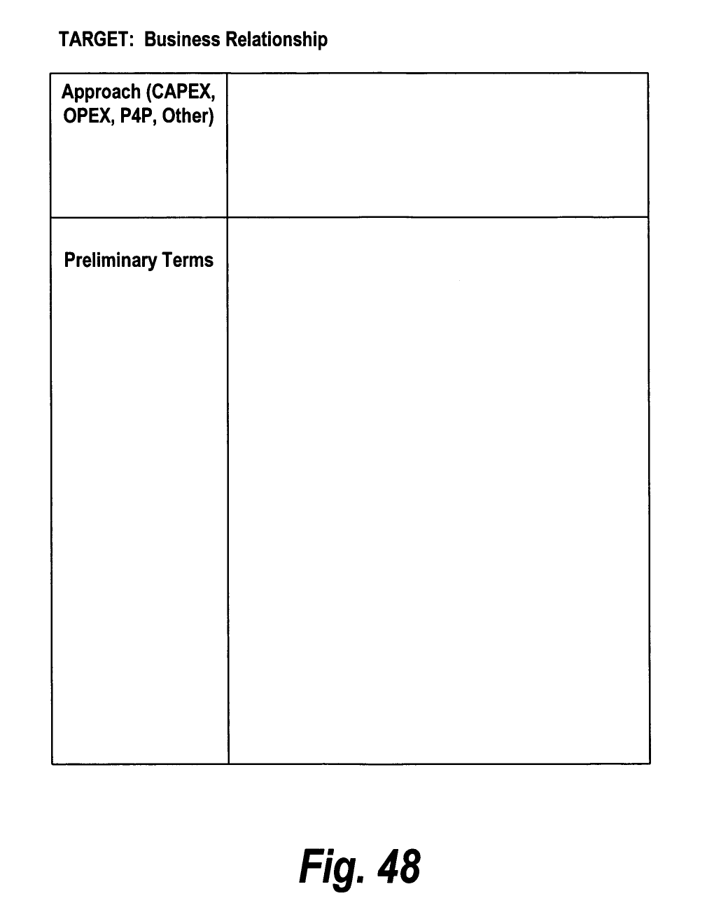

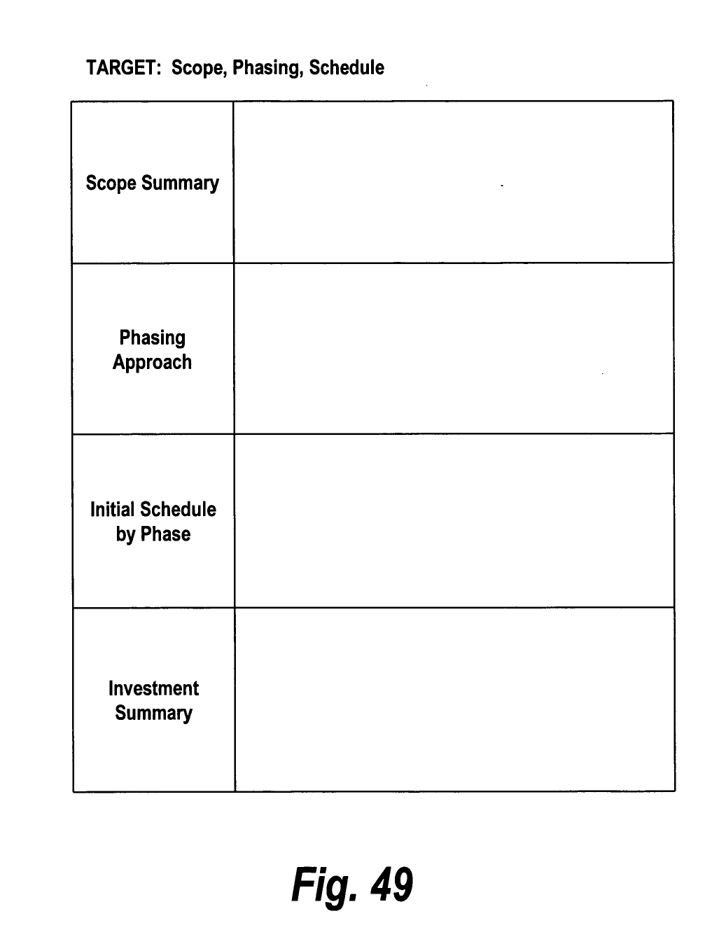

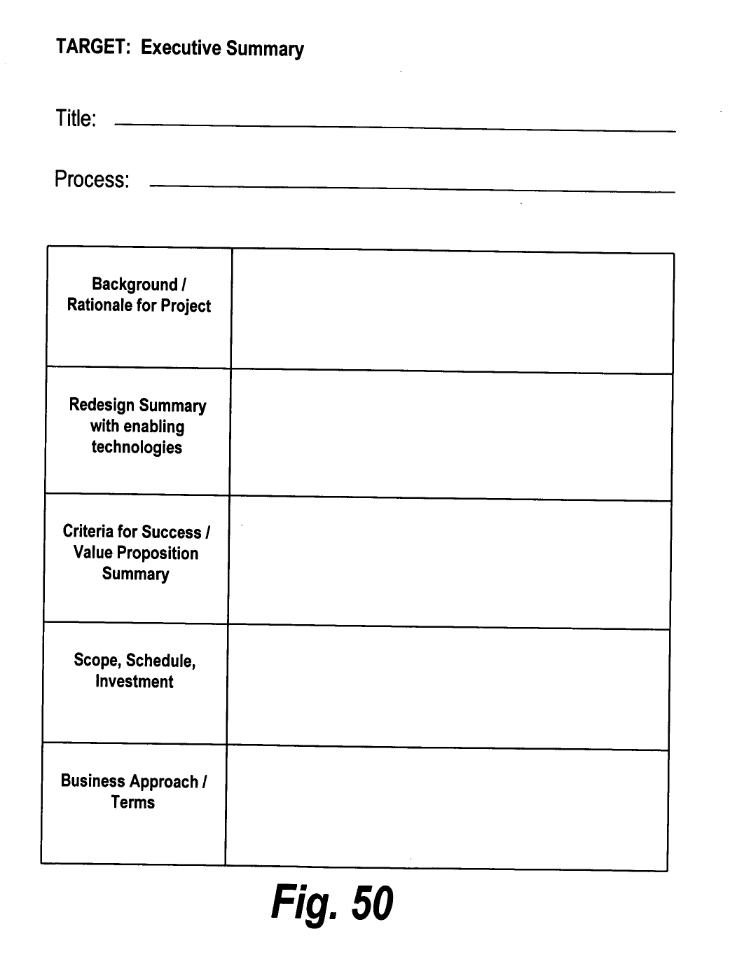

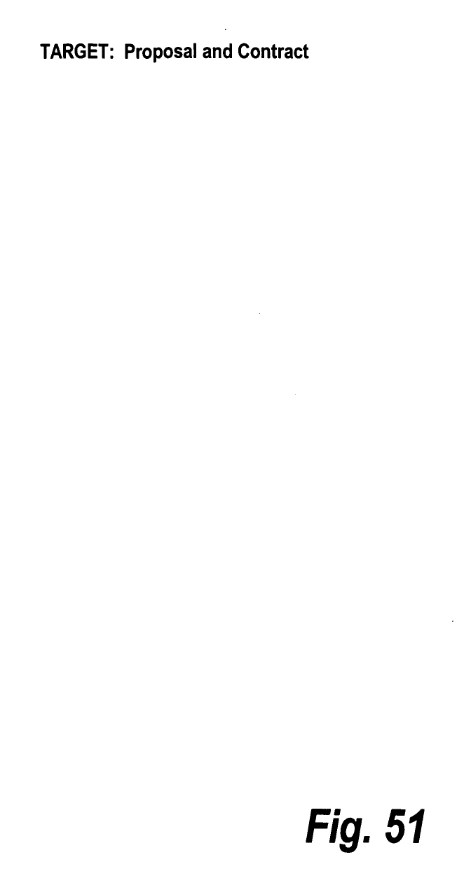

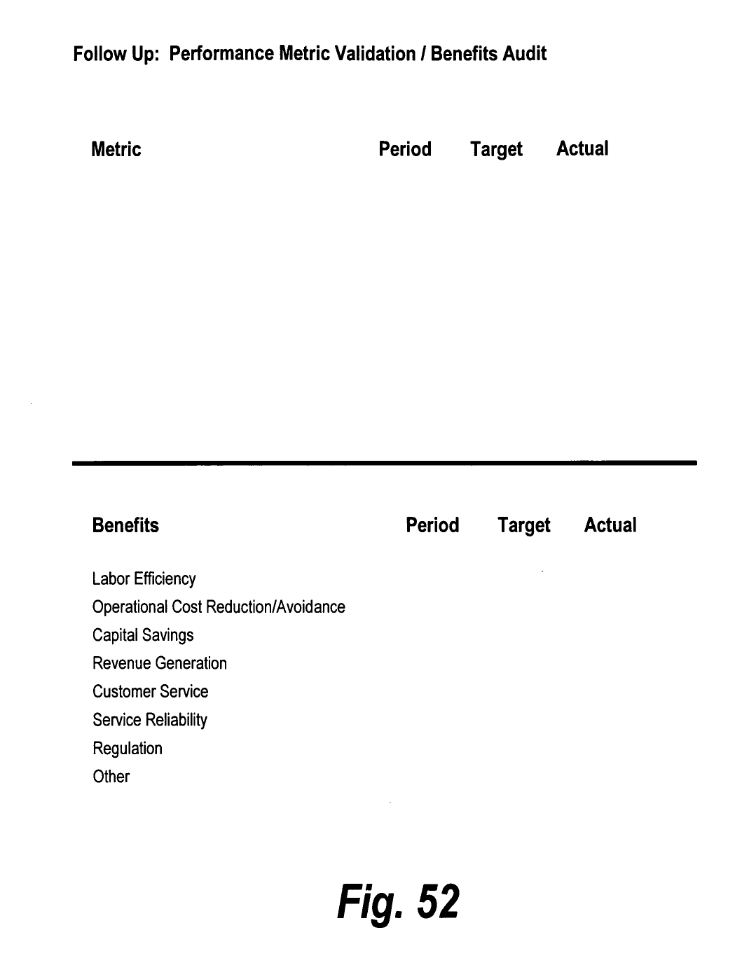

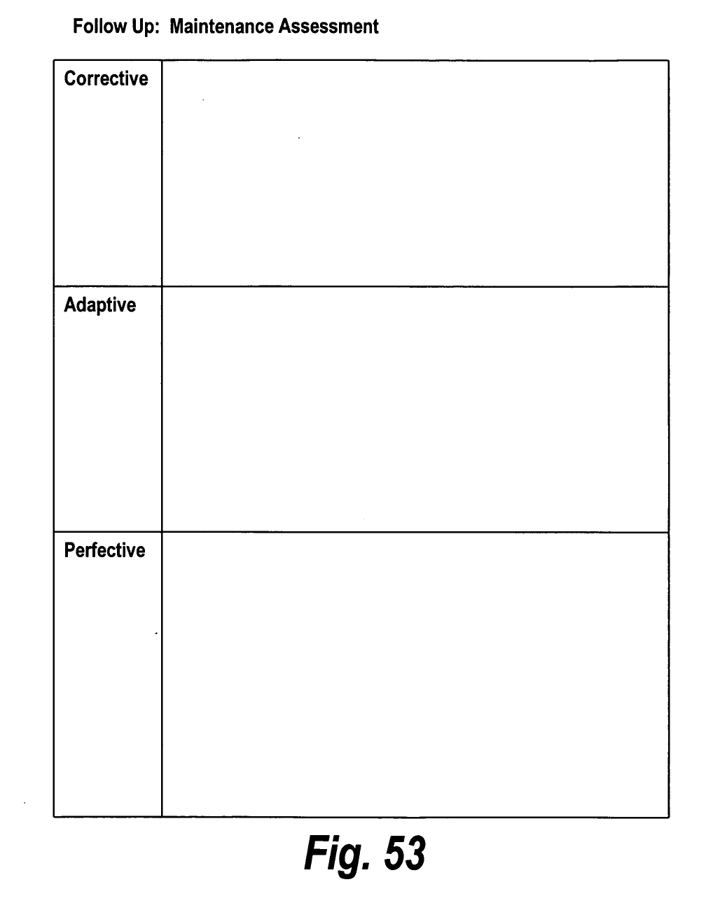

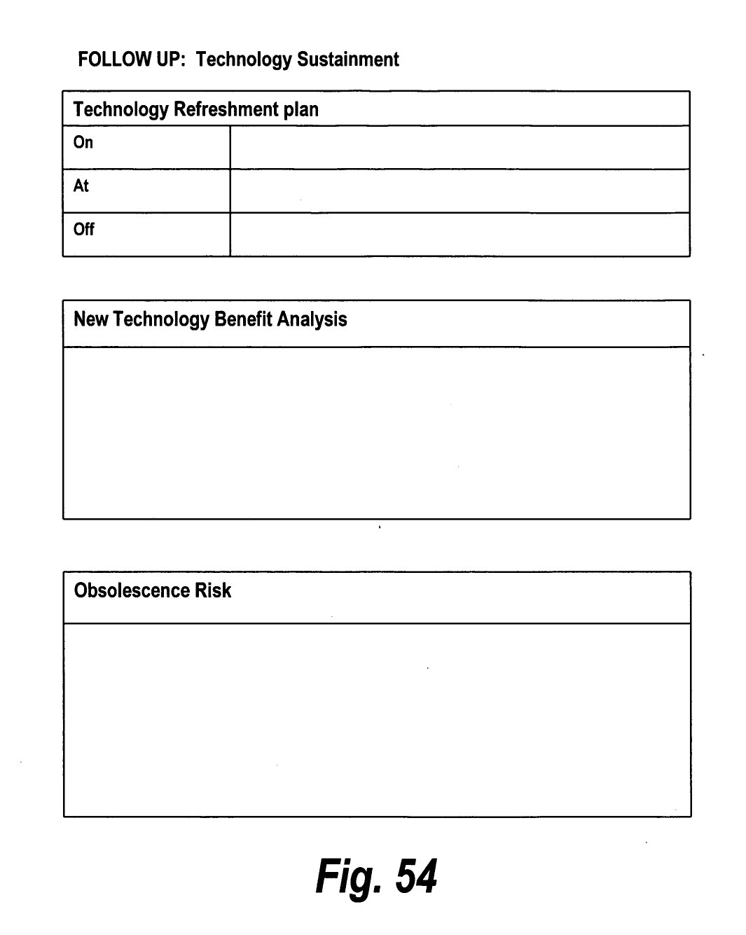

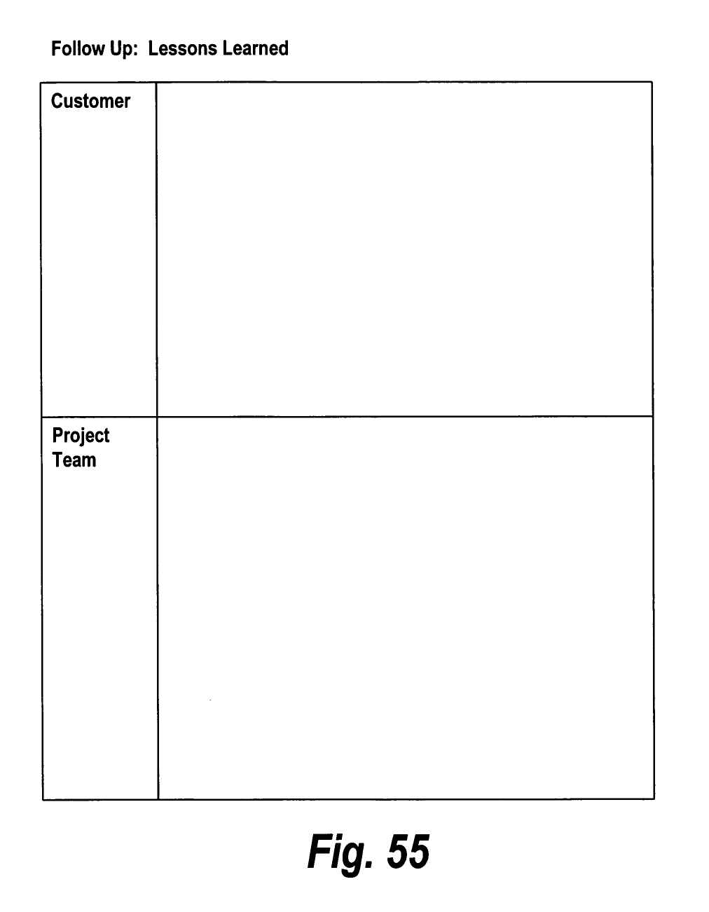

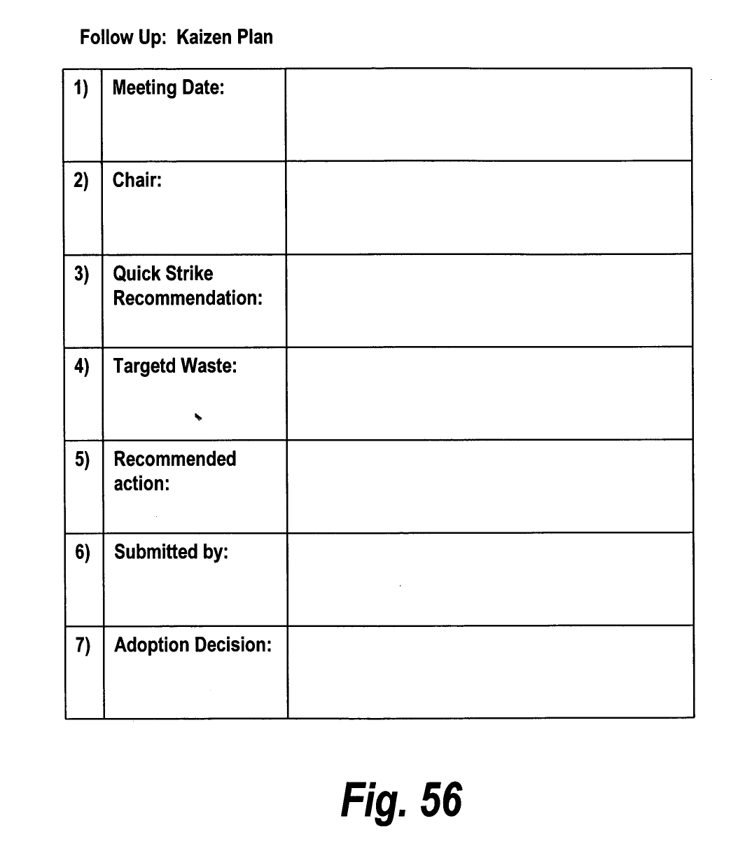

Referring to FIGS. 9-56, what is described are the templates used in a telenostics system, which are applicable across the board to many different types of businesses. These templates detail prompts that are required for completeness of a capture of a system, its evaluation, its redesign and targeted tasks that result in an implementation for improving the system as a whole.

What will be seen is that the completeness and thoroughness of the evaluation of any system requires the CERTIFY components at least in some detail for any system to be evaluated. The general prompts of capture, evaluate, redesign, target, implement, follow-up and yield are the core prompts required for the above purposes.

More particularly and especially for a fleet management system, in practicing the present invention a vehicle site fleet is visited and a business target is defined. The following steps are then carried out.

The “capture” phase is intended to document the current or “as-is” processes. Even though the redesign will most likely be a dramatic departure from the “as-is” procedure, it is important to understand the starting condition in order to: assess the potential benefits of the redesign effort; compare the “before” and “after” performance; develop the transition strategy, and assess the resources associated with the transition activity; establish the foundation for the “evaluation” phase to identify targets of opportunity that warrant special attention in the redesign effort; and to utilize flowcharting, flow measurement, and a structural analysis to aid in establishing the “as-is” picture.

The objective of the evaluation activity is to reach a common understanding of present problems. There are many diverse approaches for evaluating the captured information. Industrial engineering and operations research approaches are examples of classic approaches. They may not lead to radical process improvements. However, they are extremely useful in identifying the key performance drivers that must be addressed in the redesign effort. Cycle time reduction is a good example using measurements such as response ratios to evaluate time-based competition. A response ratio measures the elapsed time it takes to complete a customer transaction divided by the actual time spent performing the transaction. For instance, if the elapsed time for processing a credit application is 4 hours, and the actual time spent processing the application is 12 minutes, the response ratio is 20. Obviously, high response ratios indicate potential targets of opportunity for redesign. Evaluation does not stop at the metric analysis stage. “Walking the workflow” and benchmarking can also provide valuable process insight.

There are no real cookbook recipes for the actual redesign activity. Redesign involves “sowing the seeds of imagination” through system prompts to establish a creative approach to establishing a new process. It means challenging the old assumptions and the old way of doing business. It also means departing from the comforts and security of the status quo. Not everyone is well suited for this kind of activity. Many feel threatened by change rather than energized by the opportunity. Although there is no simple algorithm for stepping through a redesign effort, there are many appropriate principles established through system prompts from the templates to help guide the effort. In one embodiment the redesign is a two step approach:

The first step is to prompt a creative rethink process steps to eliminate/reduce identified issues. The second step is to apply real-time telenostics method to enable the desired end results of the stakeholders.

Those skilled in the art will appreciate that by means of the present invention, fleet management will be provided with performance based solutions for optimizing the performance metrics that are most important to their fleet/industry/financial desires. Business intelligence can be improved by affording them information that is timely, adapted to provide only the relevant knowledge that most effects performance outcomes for them, and can take advantage of multitudes of databases and information that can be “brokered” to them without the internal investment by their own IT or development organizations. As their business model, industry, or fleet changes, and the factors/metrics/knowledge which most influence their desirable performance objectives change, they can request that their performance logic model changes and/or their required level of information needs, reducing or increasing their subscription costs, but ultimately increasing their revenue by the operating/total life cycle savings with the ability to target a solution tailored toward their new or modified performance needs.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. Computerized apparatus for managing a system comprising:
a processor and a series of templates loaded into said processor for prompting an individual to capture and understand current as-is processes in said system to compare before and after performance related to said system; to develop a transition strategy for said system; and,
to redesign said system.

2. The apparatus of claim 1, wherein said system includes a fleet management system and wherein said templates include templates to prompt entry into said processor of realtime data about the location, status or condition of vehicles in said fleet.

3. The apparatus of claim 2, wherein said templates prompt optimizing driver performance and maintenance labor by prompting the user of on-condition technician to optimize maintenance tasks.

4. The apparatus of claim 3, wherein said templates prompt performing prediction performance action based on useful life.

5. The apparatus of claim 4, wherein said templates prompt the performance aggregation and analysis and information fusion to enable users to optimize fleet operation and support.

6. Computerized apparatus for prompting an individual to evaluate a system by capturing realtime data to redesign said system based on the captured data, to target problems in said system discovered during the redesign process, to implement targeted improvements and to follow-up on the implementation, comprising:
a processor;
a display; and,
a series of templates for prompting an individual to enter appropriate information into said processor, said templates including prompts relating to one of capture, evaluation, redesign, target, implementation and follow-up.

7. The apparatus of claim 6, wherein said templates are utilized to prompt the entry of information by said individual into said processor directed to capture, evaluation, redesign, target, implementation and follow-up related to said system.

8. The apparatus of claim 7, wherein said display presents the results of the processed information.

9. The apparatus of claim 8, wherein the information entered to complete said templates permits an individual to evaluate captured data and to view a suggested course of action.

10. The apparatus of claim 8, wherein said templates relating to capture include prompts for the entry of information relating to at least one of Process Description, Stakeholder Summary, Asset Environment, Process Map Diagram, Organization Structure, Constraint Summary, Decision Capture Chart, COCO Listing, Current Metrics, Data Capture Mechanisms, IT Structure, Information Flow, Wireless Structure, PST Summary, Process Personnel, Competitor Understanding, Opportunity Listing, and Interview Worksheets.

11. The apparatus of claim 6, wherein said templates relating to evaluation includes prompts for the entry of information relating to at least one of Value Stream/Waste Analysis, Metric Analysis, Issue/Error Analysis, Financial Impact, Worksheet Benchmarking, PopTech Gap Analysis, TOOL Summary.

12. The apparatus of claim 6, wherein said templates relating to redesign includes prompts for the entry of information relating to at least one of Design Principle Analysis, PopTech Assessment, Edge Analytics, Real-time Data Plan, a Redesign Storyboard, Preliminary Cost/Benefit, Decision/Action Summary, KPM Analysis, Risk Summary, and Technology Validation.

13. The apparatus of claim 6, wherein said templates relating to target information includes prompts for the entry of information relating to at least one of Redesign Storyboard Summary, Target Performance Metrics/Business Return, Business Relationship: CAPEX, OPEX, P4P, Scope, Phasing, and Schedule, Executive Summary, Proposal and Contract.

14. The apparatus of claim 6, wherein said templates relating to implementation includes prompts for the entry of information relating to at least one of Work Approach: Design, POP (on, at, off), Collection, POP Support, Architecture, Communications, Back End, Develop, Integrate, Deploy, Project Management: Project Integration, Project Scope, Project Time, Project Cost, Project Quality, Project Human Resources, Project Communications, Project Risk, Project Procurement.

15. The apparatus of claim 6, and further including templates relating to follow-up of the implemented changes to said system.

16. The apparatus of claim 15, wherein said follow-up templates include prompts to follow-up any implemented changes in said system.

17. The apparatus of claim 16, wherein said follow-up prompts include prompts to consider Performance Metric, Validation/Benefits Audit, System Maintenance (Corrective, Adaptive, Perfective), Technology Sustainment, Lessons Learned, Kaizen Plan.
